(19) United States
(12) Patent Application Publication
(10) Pub. No.: US 2006/0261931 A1
(43) Pub. Date: Nov. 23, 2006

(54) Automobile security defence alarm system with face identification and wireless communication function

(76) Inventor: Ziyi Cheng, Tianjin (CN)

Correspondence Address: J C PATENTS, INC., 4 VENTURE, SUITE 250, IRVINE, CA, 92618, US

(21) Appl. No.: 10/568,849

(22) PCT Filed: Aug. 13, 2004
(86) PCT No.: PCT/CN04/00945

§ 371 Date: Feb. 15, 2006

(30) Foreign Application Priority Data
Aug. 15, 2003 (CN) 03153509.7
Aug. 29, 2003 (CN) 03156040.7
Sep. 16, 2003 (CN) 03156944.7
Oct. 10, 2003 (CN) 200310100132.3

(51) Int. Cl. B60R 25/10

(52) U.S. Cl. 340/426.1; 340/5.53

(57) ABSTRACT

An automobile alarm system includes: (1) a face identification and discrimination system, which consists of low-light, visible light, infrared light, and thermo-luminescence camera and/or digital camera device for photograph of inside and outside of automobiles, and face identification and discrimination hardware and software system for testing whether a mask or facial adornments or whether his/her face is directed at the camera; (2) redundancy device and/or redundancy function modules, anti-interference system for communication and anti-destructive detection system; (3) a automobile status recorder, which can record the statuses on the inside and outside of the automobile before, during and after an emergent event picked up by the camera; (4) a multi-functional burglar, anti-destructive and anti-hijacking alarm for automobiles, which can transmit a radio image to a remote equipment for reporting an incident. This invention can also be used for every supervision systems.

### TECHNICAL FIELD

The present invention relates to an automobile safety defense and alarm system with face identification and radio communication functions through the pictures taken by means of visible light, low-light and/or infrared, thermo-luminous infrared camera devices and photograph devices and/or numerical code camera devices, in particular, the present invention is related to the following items and their principals and implementing methods: (1) A face identification system, which can take the pictures from inside or outside of an automobile with visible light, low-light and/or infrared, thermo-luminous infrared camera devices and photograph devices and/or numerical code camera devices and can identify whether or not the driver and other peoples have face masks or face ornaments, whether or not their faces are directed at the camera; (2) Redundant parts and/or redundant functional modules, and anti-interference communication system and anti-destroying detection system, which can strengthen anti-destroying function; (3) An automobile status recorder, which will record the information and data of inside and outside the automobile taken or picked up by the camera before and after a burst event is happened and when the event is happening, and that recorder and the radio communication system form a radio-communication automobile status recorder of an burst event; (4) A multi-functional burglar-proof, anti-destroying and anti-hijacking alarming system. Every kind of image and data information picked up by the radio communication system of the alarming system and the images and data information in the automobile status recorder, which are transmitted to a remote monitor and control center for alarming.

Note: Visible light, low-light and/or infrared, thermo-luminous infrared camera devices and photograph devices and/or numerical code (digital) camera devices in the present specification are hereinafter referred to as photo devices.

Infrared, thermo-luminous infrared photo materials and/or numerical code camera materials, in which: the principle of infrared photo material is that an external infrared source lights an object to be shot, and the infrared photo material captures the infrared lights reflected from the object. That principle is the same as that of visible light camera. The principle of thermo-luminous infrared photo materials (passive infrared photo materials) and thermo-luminous electric infrared sensing and monitoring devices is to capture the lights given out by the object itself. Those devices also have the name of thermo-imaging photo device and can be made by infrared focusing plane array technique or other kind of technique. The thermo-luminous electric infrared sensing and monitoring device is a single device or multiple plane sensing devices and not a plane array so that it can be replaced with a thermo-luminous electric infrared sensing and monitoring device. Both of infrared and/or thermo-luminous infrared photo devices can use a same device or different devices, including infrared focusing plane array device or non-plane array device made of InGaAs, HgCdTe, PtSi, PtSi, InSb, HgCdTe and GaAlAs/GaAs, GeSi/Si heterogeneous structure and other materials. At present, infrared focusing plane array manufacturers and non-refrigeration infrared focusing plane array manufacturers include USA Honeywell, Texas Instruments, Lockheed Martin Corporation and so on. Present general commercial arrays are 1, 2, 2×2, 160×120, 320×240 units and so on, in which 1, 2 and 2×2 units can be made to be a thermo-luminous electric infrared sensing and monitoring device. The products that can be available in the market are IR FlexCam, IR SnapShotI infrared photo instrument, IR-InSight infrared thermal imaging instrument and IR-160 made by USA Infrared Solutions, Inc. IR-160 is a thermal imaging photo system with high-resolution ratio.

At the same time, the present invention's automobile safety defense and alarm system and its each device, assembles, and sub-systems with different functions, such as the monitoring system in the camera to identify a criminal suspect with a face mask or face ornaments, automobile status recorder (Black Box) and so on, not only can be mounted on an automobile as its safety defense and alarm system, but also can be used in any places where there are needed that safety defense and alarm system or its sub-systems, devices, assembles or modules, such as bank, building, office, warehouse, home etc as well as each kind of vehicles, ships, air planes and so on for safety, monitoring and alarming. In addition, they can be used as a safety alarm for instrument, equipment or other valuables. The <Face Identification System> that can identify whether or not the driver and other peoples have face masks or face ornaments, whether or not their faces are directed at the camera can be used in each kind system for burglary insurance, anti-destroying, safety, monitoring, alarming and defense etc. For example, put it in ATM of a bank, used for a burglar-proof door or for any suitable and required places.

By means of redundant parts and/or redundant function modules, and anti-destroying sensor, anti-destroying photo device and through anti-interference radio alarming function, the system's function is then strengthened. Using the time difference before the system is destroyed and after the system has been destroyed, each kind of image and data information for a burst event are transmitted to a remote monitor and control center for alarming on time.

### BACKGROUND TECHNOLOGY

The burglar products of automobile were developed through several generations:

1. Main products in the first generation were mechanical locks. The second generation was electronic burglar locks, and their secret codes are transmitted with infrared or radio wave, which was easy to be captured and transcribed by the criminal suspect. That kind of burglar system may be alarmed very loudly when it is impacted, but its alarming distance is limited.

The third generation is intelligent burglar products, such as numerical code burglar lock and fingerprint burglar lock etc. They consist of multiple sensors (such as vibration sensor, lock test sensor, signal receiver and so on), which detect the vehicle status and send the information detected continuously to a burglar central processor and then are processed and judged by special program in the processor. In the case that some special conditions are met, then a corresponding program will be started to make an alarm through a control device (For example, if somebody want to open the car door, generator cover, baggage cabin door, or want to go into the car without key or remote controller, the burglar system will start an alarm program to make sound and flash the head lamps or steering lamps, and at the same time, the burglar system will cut up start circuit or ignition circuit or other interlock system for the generator), so as to realize the purpose of guarding against theft and robber. Using mobile communication system such as GSM or CDMA network system, no matter where you are, once somebody attempts to open your car door or start your car, your mobile telephone will immediately receive an alarm and a telephone call. When you receive that telephone call, it will be possible for you to monitor your car. After confirming that your car is being stolen by car robber, you can immediately take measures to guarantee your car, including reporting to the police. With the electronic technology developing fast, the car-stealing method is also changed from traditional line breaking to using high-tech electronic products. That generation products have more progress than previous two generations' products, as they are lack of initiative for guarding against theft, the owner of the car can not learn his/her car's status on time.

2. At present, the newest generation is such network vehicle burglar system that a radio communication system transmits the images of a vehicle taken by a general camera/numerical code camera to the communication satellite, then through positioning the vehicle by GPS (Global Positioning System), and finally the information of the vehicle will be sent to a remote control center for processing. That system will lock or stop the vehicle ignition or start system to achieve burglar-proof goal. At the same time, the alarming information, the position of the vehicle that has made an alarm and the driver's picture can be transmitted to the alarm center through the Global Positioning System. GPS burglar device has many functions. It can not only make a real time monitoring to a vehicle's position, but also can hear the sound from the vehicle through the vehicle mobile telephone, take the pictures for driving through the camera, and can close the vehicle oil way and turn off electrical circuit and lock all the doors and windows through mobile telephone if necessary. The remote alarm center can confirm the vehicle's position precisely in two minutes.

Those products have outstanding results in guarding against thefts. Their shortcomings are as follows:

(1) If the criminal suspect firstly destroys some parts in the safety defense and alarm system and/or functional modules, or if the parts and/or functional modules are damaged by themselves, for example, the antenna or some modules are damaged, as there are no redundant parts and/or redundant function modules, it is possible to lost the images and information that are being transmitted to the remote control center. The remote monitoring persons may not know the criminal suspect's facial features, which will cause difficult for solving the case and capturing the criminal suspect.

(2) If a criminal suspect who knows the secret code of the burglar lock or has a key for that car, the alarm system may consider he/she is a legal driver and may not send an alarm, which will result in such case that the owner doesn't know his/her car was stolen yet.

(3) If a driver is hijacked, because the driver is a legal one who is driving right now, so the car may not be in alarming status, or there is no time for some legal driver to put the alarm button down while they are being robbed, then the safety defense and alarm system may not send an alarm information, so its burglar-proof function will be lowered greatly.

(4) At present, the face identification software doesn't have the functions to confirm whether or not the driver and other peoples have facemasks or face ornaments, whether or not their faces are directed at the camera so that the face identification system can't make a correct identification. In the case a criminal suspect wears a facemask, a visible light camera can not identify the criminal suspect. For that reason, the face identification software can not be used in the automobile burglar system and can't protect the driver's private matter from letting out.

(5) At present, in general, the driver identification system in an automobile safety defense and alarm system and/or automobile burglar device uses vehicle door and electric ignition switch lock, electronic secret code lock, electronic interlock or fingerprint identification lock or other electronic and mechanical locks. A premise for the fingerprint identification lock is that the driver's fingers must be clear, otherwise, the fingerprint identification lock can't identify the driver's fingerprint so that the car could not continue to run.

(6) At present, the automobile safety defense and alarm system records only the matters that the burst event is being happened and after the burst event has happened. Therefore, it is not possible to know what was happened before.

(7) At present, the black box for vehicle use records only the operation of each mechanical part but real road condition when an event is happened. In the case that a vehicle is burned or exploded, the data in the black box may be disappeared, so we may not have the information for the burst event.

(8) At present, only the contents on the vehicle instrument board are displayed.

### SUMMARY OF THE INVENTION

(1) The present invention provides a dynamic monitoring method to the matters in a vehicle by means of thermo-luminous electrical infrared sensing and monitoring devices, and/or camera materials, and other general burglar devices. When a person has gone or intents to go into a vehicle, the camera devices inside and outside the car will be started to take images, which will be sent to a remote control unit through a radio communication system for alarming, and at the same time, by means of computer identification method, such as biological identification method (face identification technique, iris identification, retina identification, fingerprint identification, voice recognition, identification of the shape of a mouth, and handwriting identification, etc) and/or secret codes, that person is verified.

In the case a criminal suspect opens the door with a key and goes into the car, it is also impossible to run the car. The police can capture the criminal suspect according to the images. Computer face identification can confirm whether or not the driver is a legal driver, otherwise, the alarm system will send information for a requirement to verify whether or not the driver is a legal driver (for example, a confirmation lamp will be flashed). If the confirmation is negative, that driver will be considered to be a robber, whose images and other information inside and outside the car will be sent to the remote control center. If other functions of GPS can be used at the same time, it will be easier to help police capture the criminal suspect. In addition, that automobile alarm system has a function to stop the criminal suspect.

In the case a driver who is a legal one has gone into a driver's cab, through computer face identification, the driver is confirmed to be a legal driver whose face characteristics are in conformity with those in the computer, then the driver's images will not be sent to the remote control center, which may reduce operation load of the center and protect legal driver's private matter from letting out.

(2) Using redundant parts and/or redundant functional modules, if a partial redundant parts and/or redundant functional modules are broken, there is an alarming function in the alarm system. Even though all the redundant parts and/or redundant functional modules are broken, by means of the time difference between before and after each part is broken, the images and each kind of information will be sent to the remote control center through radio transmission, so that alarm function is still remained. Because redundant parts and/or redundant function modules, and anti-destroying sensor, anti-destroying photo device are used in the alarm system, if a criminal suspect intents to destroy a partial devices and/or modules, for example, an antenna in the machine chamber at the vehicle head, the sensors in the chamber will sense that cover opening action and start the anti-destroying photo device to capture the destroyer's image at the first time, and an alarm will be made out through redundant antenna and/or modules, which strengthens burglar-proof, anti-destroying and anti-hijacking functions of the automobile safety defense and alarm system.

(3) An automobile status recorder for burst events (Black Box for Automobile Use) can cyclically register and record the images and data information inside and outside the automobile picked up by the camera device when and after the burst event has happened. Therefore, the automobile alarm system can record overall process of that burst event, including the matters in the car and real conditions of the road. As there is a preventive cover covering the black box and a standby power source, therefore there is a short time from the beginning of a trouble to the time the data in the black box are disappeared, in that short time those data can be transmitted by the radio communication system to the control center.

(4) The anti-destroying camera devices and alarm sensors mount under the chassis, in the lamp covers and in the car can effectively protect the vehicles from destroying and capture the destroyer's images, and then an alarm will be made out through redundant antenna and/or modules, which also strengthens burglar-proof, anti-destroying and anti-hijacking functions of the automobile safety defense and alarm system.

(5) Because the infrared, thermo-luminous infrared camera and/or numerical code camera has a certain penetrability to the textile or fabric, so infrared, thermo-luminous infrared camera and/or numerical code camera can take pictures of the criminal suspect and find out whether or not he/she wears a mask if his/her mask can be penetrated with the infrared. If the criminal suspect wears a mask that can't be penetrated with the infrared, his/her mask will be found out and an alarm will be sent out immediately.

(6) Using the present invention's information display system that consists of the camera devices and display devices of the present invention. Using the forward looking, back looking and side-looking system that consists of camera devices and head up display and/or the multi-functional head up display system that can display multiple messages.

(7) A radio communication monitoring and controlling system can avoid communication interrupt resulted from man-made influence, so as to strengthen burglarproof function.

(8) Existing GPS automobile burglar system continues to send the position information of a vehicle to the monitoring and controlling center, so it can not protect the driver's private matter from letting out. The present invention's automobile safety defense and alarm system will sent information about that vehicle to the remote control center only when a burst event is happened, which may reduce operation load of the center and protect legal driver's private matter from letting out.

The present invention is an automobile alarm device. This device uses single or multiple camera devices mount in the automobile car to take the criminal suspects' images and then transmit those images and alarm information to a monitoring and controlling center or to a monitor/the owner of the vehicle through a radio communication system. It is possible to mount a face identification software in the CPU of the alarm system to verify whether or not the driver is a legal driver whose information has been recorded in the alarm system, otherwise, the alarm system will start the alarm and/or burglar equipment.

The present invention can take the images with monitoring camera devices and/or numerical code camera and send them to a remote monitoring and controlling center through a radio communication system for alarming. In addition, the present invention can identify whether or not the person in the driver's cab is a legal driver. The present invention can create a whole automobile safety defense and alarm system of its own, or a comprehensive system with other existing burglar products, such as the first, second and third generation burglar products, and/or GPS automobile burglar system, or the present invention's automobile burglar system is connected with each kind of electronic devices in the vehicle to form a multi-functional automobile electronic system that will include burglar alarm, electronic control and entertainment functions. For example, connection of the radio communication module with the monitor can watch TV transmitted by Radio Network and sign on Internet when the vehicle is running. If connecting the head up display to the camera devices with forward and backward directions inside and outside a vehicle, it may be used as a head up display for forward-going or backing use, or a CPU module in an alarm device, or a functional sensor for each kind of automobiles, such as speed sensor, oil weight sensor and so on, so as to have multiple functions of automobile electronic automatic control.

The present invention can be equipped with single kind or multiple kinds of burglar sensors, which may be initiative burglar sensors or passive burglar sensors; for example, initiative burglar sensors can be electronic burglar lock, as well as numerical code burglar lock, fingerprint burglar lock, vibration sensor, door lock test sensor, signal receiver and infrared back-feed tester etc, the secret codes of which are transmitted in infrared or radio waves. The passive burglar sensors can be passive infrared sensing monitor, camera dynamic monitoring system and so on, as well as GPS vehicle movement and position sensor and so on. Passive infrared sensing monitor and camera dynamic monitoring system use the camera devices to monitor the matters in the vehicle continuously. Once somebody intrudes into the vehicle, it will start the alarm system. The burglar sensor uninterruptedly tests the statuses in the vehicle and sends the signals to a burglar CPU on time, which will be processed and judged by a special program in the burglar CPU. When a special condition is met, a corresponding program will be started to make an alarm and take burglar control measures (for example, if somebody want to open the car door, generator cover, baggage cabin door, or want to go into the car without key or remote controller, the burglar system will start an alarm program to make sound and flash the head lamps or steering lamps, and at the same time, the burglar system will cut up start circuit or ignition circuit or other interlock system for the generator), and capture the images through camera system and/or make face identification with the face identification system, in addition, start communication system to send each kind of materials such as vehicle status, position, face characters of the criminal suspect to the monitoring center, so as to realize the purpose of guarding against theft and robber.

The present invention's automobile safety defense and alarm system with image-capturing and radio communication functions (including automobile burglar alarming principle and implementation method) can be used not only in automobile burglar alarm and but also in any places where there are needed that safety defense and alarm system, such as each kind of vehicles, ships, air planes, buildings, dock, warehouse and so on for safety, monitoring and alarming.

The present invention's automobile safety defense and alarm system not only can be mounted on an automobile as its safety defense and alarm system, but also can be used in any places where there is needed that safety defense and alarm system, such as office, warehouse, home, building, yard, dock etc as well as each kind of vehicles, ships, air planes and so on as their alarm or as the face identification burglar lock and burglar monitoring device. In addition, they can be used as a safety alarm for instrument, equipment or other valuables. Through face identification, a person who goes into the vehicle is confirmed to be a legal driver, otherwise, the alarm system will start the alarm, which will be sent to a near or remote monitoring center. The present invention's burglar-proof device can create a independent defense and alarm system of its own.

According to the design requirements, the present invention's automobile safety defense and alarm system not only can be mounted on an automobile as its safety defense and alarm system, but also can increase automobile automatic control functions according to the design requirements. For example, according to DHWG (Digital Home Working Group) standard, design each kind of automobile communication and entertainment functions.

### BRIEF DESCRIPTION OF THE DRAWINGS

These and other features of the present invention will now be described in detail with reference to the accompanying figures in which:

FIG. 1 is the present invention's basic structure block diagram.

FIG. 2 is the present invention's circuit diagram of camera part.

FIG. 3 is the present invention's circuit diagram of thermo-luminous electric infrared sensor for temperature difference alarm.

FIG. 4 is the present invention's block diagram of system program to make a dynamic monitoring of the conditions in a vehicle with camera devices.

FIG. 5 is the present invention's block diagram of system program about photographing, face identification and alarm system.

FIG. 6 is the present invention's block diagram of main system program about automobile alarm system.

FIG. 7 is the present invention's block diagram of system program about burglar brake control system.

FIG. 8 is the present invention's circuit diagram of thermo-luminous electric infrared sensor for temperature difference alarm.

FIG. 9 is the present invention's floor plan of camera devices.

FIG. 10 is the present invention's position figure of antenna, camera devices and sensors in the vehicle. FIG. 10a, FIG. 10b and FIG. 10c are top view and side view of a vehicle and section view of instrument panel in the driver's cab individually.

FIG. 11 is the present invention's block diagram of radio alarming communication system.

FIG. 12 is the present invention's block diagram of automobile monitoring system.

FIG. 13 is the present invention's block diagram of photographing and image transmitting system.

FIG. 14 is the present invention's block diagram of automobile redundant monitoring system.

FIG. 15 is the present invention's block diagram of automobile anti-interference communication monitoring system.

FIG. 16 is the present invention's automobile monitoring program block diagram of the identification of a driver with facemask or face ornaments by means of camera devices.

FIG. 17 is the present invention's monitoring program block diagram of automobile status recorder (Auto Black Box).

FIG. 18 is the present invention's block diagram of chassis anti-destroying and monitoring system by means of camera devices.

FIG. 19 is the present invention's block diagram of monitoring and alarming system when a burst event to a vehicle is happened.

FIG. 20 is the present invention's block diagram of anti-interference radio communication alarming system when stopping.

FIG. 21 is the present invention's block diagram of anti-interference radio communication alarming system when running.

FIG. 22 is the present invention's monitoring program block diagram of a radio communication automobile status recorder (auto black box) when and after a burst event is/was occurred.

FIG. 23 is the present invention's block diagram of <Face Identification System> to identify whether or not the driver's face is directed at the camera.

FIG. 24 is the present invention's block diagram of <Face Identification System> to identify whether or not the driver and other peoples have face masks or face ornaments.

FIG. 25 is the present invention's block diagram of animal characters identification and judgment system.

FIG. 26 is the present invention's block diagram of facial unusual expression identification system.

The next will refer to attached figures and explain embodiments of the present invention. In the following explanations, the known functions or structures have not been explained in order to lay stress on the key points.

### DESCRIPTION OF EMBODIMENTS

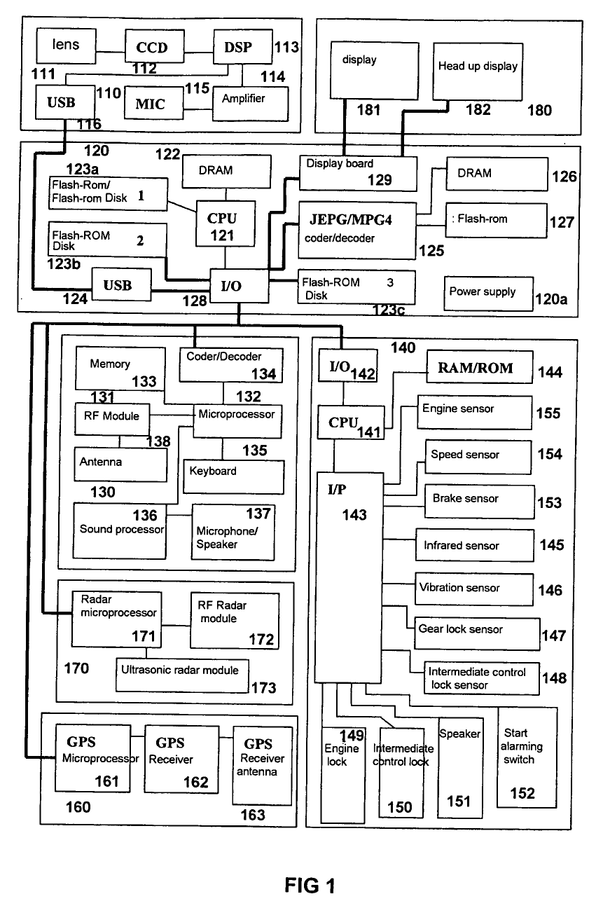

FIG. 1 is the present invention's basic structure block diagram.

The present invention includes: Camera device (and/or digital camera) and/or sound-receiving module 110, communication and/or anti-interference communication module 130, CPU 120, alarm sensor and vehicle locking module 140, GPS positioning module 160 and sensing and alarming radar module 170 as well as communication antenna 130 and GPS antenna 163 etc.

Among those parts, camera device (and/or digital camera) and/or sound-receiving module 110 includes:

Camera lens 111, and sensitive elements such as charge-coupled device (CCD) or CMOS sensitive element 112. According to design requirements, image sensor can use charge-coupled device (CCD), charge—injected device (CID), charge-scanning device (CSD), photodiode array device (PAD), MOS image sensor, CMOS image sensor and other kinds of image sensors, in which CMOS image sensor (Complementary Metal oxide semiconductor Image Sensor) may be: CMOS-PPS, CMOS-APS and logarithmic transformation CMOS image sensor and so on. The structure of CMOS-PPS is light-sensitive diode, and CMOS-APS has light-sensitive diode and optical grating structures etc. According to design requirements, camera lens 111 can be every type of camera lens such as fixed-focus lens, or zoom lens, or automatic light-metering and self-adjustable aperture lens, or fixed aperture lens, or automatic focus lens, or fixed focus lens, or a small lens module in the camera module with 2.5 times of optical zoom and automatic focus functions made by SEIKO ( [symbol] [symbol] [symbol] [symbol] [symbol] ) and inserted in mobile telephone, or other kind of lens. As CMOS/CCD sensitive elements used in numerical code camera and pickup camera can receive infrared waves, in order to take the infrared picture and dynamic images, it is required to equip with an infrared filter and form an infrared camera device. The infrared filter can be M&K 1000 infrared filter made by USA M&K optical company, and HOYA infrared photo-scope etc. Of course, other kind of infrared camera devices can be used. Signal processor DSP 113 processes sound signals, the signals received by the sensitive elements, video and voice frequency output signals, and/or image and sound signals. Pickup MIC115 receives sound signal, the amplifier 114 amplifies the output signals from the pickup MIC and/or the sound signals after digital signal processing. Picture-taking and sound-receiving module power source 116 and output interface 117. According to the design requirements, the output interface may be analogue TV voice frequency signal output interface, or digital signal output interface, or cable interface, such as, analogue TV voice frequency signal output interface, and digital signal output interface USB and 1394 and so on, or other kinds of radio communication interfaces such as infrared interface or 802.11x, or NEC electronics' parallel-to-serial converter interface, bridge connecting IC “μPD161451”, the image data transmission lines are reduced from 18 to 4 lines. Through those 4 signal lines (2 pairs), a maximum 128M bit/s transmission speed can be available. Other radio communication systems, and Lanya( [symbol] [symbol] ) personal local network and other radio communication input/output interfaces can also be used.

Camera device (and/or digital camera) and/or sound-receiving module 110 can be each kind of existing camera devices or picture-taking and circuit modules in those devices such as CCD sensitive devices/USB interface/Built-in speaker/camera device modules or overall unit of QuickCam Pro 4000, or SHARP CCD camera module LZ0P371K, or SHARP CMOS image sensor LR38637 module etc, and SHARP logarithmic transformation CMOS image sensor module and each kind and type of camera devices or camera modules.

The present invention's camera device can be single device or multiple devices. When several camera devices are used, they can be mounted on different positions to take pictures from different directions, that is, they can be regarded as redundant camera devices to protect destroy of the criminal suspect and avoid that the camera lens is covered by the criminal suspect and loses camera function.

The main function of the camera device and/or sound-receiving module 110 is to take pictures or images, and/or to receive the sound. Its functions can be increased or decreased according to the design requirements, for example, increasing infrared lighting and/or visible lighting function etc.

Pickup MIC115 that receives sound signal amplifies the output signals from the pickup MIC and/or the amplifier 114 amplifies the sound signals after digital signal processing can put in camera device (and/or digital camera) and/or sound-receiving module 110 or in other position.

An analogical interface can be used between each module (for example, between the camera device and/or sound-receiving module 110 and CPU), for example, the communication can be carried out through voice frequency and/or video frequency cable, or through digital communication interface such as USB interface, IEEE 1394 port, optical fiber communication interface etc. Each module can be communicated with other modules through analogical signal interface and/or digital signal interface.

Each kind of burglar sensors in the alarm sensor and vehicle locking module 140 can be used, including infrared sensor 145, vibration sensor 146, gear lock sensor 147, intermediate control lock sensor 148 and so on. Each kind of burglar alarming interlock units can be used, including intermediate control lock 149, generator lock 150, alarm speaker 151 and alarm start switch 152 etc. There can be mounted performance, function, status sensors to the each part of the vehicle, such as generator sensor 155, speed sensor 154 and brake sensor 153 and so on. The alarm unit can be controlled by the alarm sensor and the automobile-locking module CPU 141 with the status signals of each kind of sensors and the working status signals of each type of mechanical parts in the automobile through I/P interface. When a criminal suspect is opening a car door or has intruded into the car, that process can be monitored in following measures, for example, (a) by means of thermo-luminous electric infrared sensing and monitoring devices 153, sensing the person in the car at night and daytime without illumination. In that situation, the infrared lamp can be started working at night or when the daylight is dark or only when the criminal suspect has intruded into the car. In addition, a visible lamp can be used for illumination compensation, so as to take a clear picture. It is possible to measure illumination level in the vehicle to decide whether or not the infrared lamp and/or visible lamp should be started when the criminal suspect has intruded into the car. (b) Carrying out dynamic monitoring to the situations in a vehicle through camera devices. When the criminal suspect has intruded into the car, camera devices and radio communication system are automatically started for alarming. According to the result of face identification, judge whether or not the person in the car is legal driver, so as to start the locking function. (c) Using infrared reflection sensor. (d) Using each kind of alarm switches such as burglar alarm switches at steering wheel or other positions in the vehicle, or using each kind of burglar sensors.

CPU 120 includes: CPU 121, which can be a single CPU or multiple CPUs for parallel or serial operation. According to the design requirements, each kind of CPU can be used, such as the CPU for desk-top computer, notebook computer, industrial control computer, pocket computer, or such CPU that PXA series Intel processor with ARM structure such as Intel PXA270 processor with multi-configurations that has clock rate 312 MHz 624 MHz and equips with 64˜256 MB Intel StrataFlash flash register, and also can be TI OMAP series CPUs, and some special systems that consist of each kind of gate arrays. Dynamic RAM 122 and ROM can be flash memory 1, 123a can use each kind of ROM, such as ROM, EPROM each kind and type of FLASH ROM and so on. In ROM there can be memorized each kind of data of basic I/O system (BIOS), control system program, computer operating system, application system program for processing by CPU according to alarm design requirements. Those computer operating systems, application system programs and each kind of data programs can also be memorized in a mobile memory card 2 (FLASH ROM) 123b, so the dynamic RAM 122 and ROM 123a will store only basic I/O system (BIOS) for processing by CPU, but mobile memory card 2 (FLASH ROM) 123b as an operating system start disc will store only the data of operating system each kind of control system program, application system program and so on. This mobile memory card 2 (FLASH ROM) 123b can be used as a magnetic disc C of a computer, or the operating system program and each kind of application system program can be stored in a hard disc or other type memories. Because of large vibration, the hard disc is easily broken, so it will be suitable to use a mobile memory card 2 (FLASH ROM) 123b. In the case of non-moving and/or non-vibrating condition, hard disc can still be used instead of mobile memory card. Thos system program can include, for example, the operating system can use Windows, Unix, Linux, Windows® CE.NET, Symbian OS and other kind of operating system programs. The camera control system program and each kind of biological identification program such as face identification system program, fingerprint identification system program, iris identification system program, retina identification system program, handwriting identification system program, voice recognition system program and so on. ID system such as secret codes input identification system program, output image and/or voice compression circuit 125 and other control system program, alarm control system program, automobile status recorder (Auto Black Box) system program, and side-looking and/or forward looking, and/or back looking camera devices and/or auto radar module 170 monitor the conditions at front, back, right and left of a running automobile, send out danger signal immediately to protect it from impacting, indicate and/or take safety measures automatically immediately, and/or automobile automatic drive system according to road sign to control vehicle's direction and speed. Those control application system and their corresponding software can be increased or decreased according to the design requirements, or combine each other to form a new assembly of safety defense and alarm system. Mobile memory card 2 (FLASH ROM) 123b and mobile memory card 3(FLASH ROM)123c can use each kind of movable semiconductor flash-memorizing card, such as CF card (Compact Flash Card), SM card (Smart Media Card), MMC (Mult Media Card), SD card (Secure Digital Card), Memory Stick Pro and Memory Stick, USB flash memorizing card (flash memory ROM Card for USB interface) and so on. That mobile solid memory 123b\123c can also use each type of non-volatile semiconductor memory, such as each kind of FLASH ROM, EPROM and so on. That flash memorizing memory 2 (FLASH ROM) 123b 123c can be mobile memory card, or can be non-mobile printed-circuit board, on which a flash memory (FLASH ROM) 123b is mounted.

An image chip that outputs images data to the display can use a single image processing chip or a CPU or a chip set that integrates image chip.

According to the design requirements, packing and de-packing circuit of image and/or sound 125 and RAM 126, ROM 27 can be put in a CPU module 120, or in the camera device (and/or digital camera) and/or sound-receiving module 110, or in communication and/or anti-interference monitoring and communication module 130 and so on. Those images and sounds can also be packed or de-packed with either the single image and sound packing and de-packing circuit or the image and sound packing and de-packing program.

The output images and/or sounds can be packed according to each packing protocol such as JEPG, MPEG, MJPEG, XVD (“eXtended-play Video Disc” developed by USA DigitalStream), WMV (Microsoft's Windows Media Video) and DivX (developed by USA DivX Networks) etc or to H 323 image and sound packing standard. All the following image and sound packing circuit, technology or software program are able to be used: USA Droplet company's “DTV” symmetric image packing technique that is based on small wave conversion, hardware packing by image and sound packing circuit, and software packing technique by software program and CPU. The output image and sound packing circuit 125 can be set in the Image taking and/or sound receiving module 110 or other position according to design requirements.

According to design requirements, it is possible to use each kind of software system program and/or hardware circuit with face identification function, such as DCS AG company's face identification system BioID, The Academy of Science of China Calculation Institute's “Main Technology for Face Monitoring and Identification”, Xingchuang company's FaceOn Access Control face identification system program or a special persons' face character databank. Compare the image to be identified with the image data of legal driver in the databank and verify whether or not the person is a legal driver, otherwise asking or alarming information will be sent to the owner of the vehicle or to other managers through radio communication or other method. If the person is a legal one, a vehicle-unlocking program will be carried out so that the legal driver can start the vehicle. It may be possible that the image data of the person who goes into the vehicle can not be processed in face identification, and directly sent to a control center for image identification; If the person is not a legal driver, asking or alarming information will be sent to the owner of the vehicle or to other managers through radio communication or other method.

The main functions of CPU module 120 are: Receiving the alarm information from the alarm and monitor sensor or from the monitor module; Starting alarm system and collecting each kind of information, such as, and starting camera system to take pictures to the person who goes into the vehicle and starting communication system to make a face identification of the alarmed information for that person; Transmitting the identified face data, the image data of the legal driver, the image data of other persons who go into the driver's cab, and the vehicle information and so on to the control center, and; Implementing commands to control the vehicle from the control center and/or next operations and so on.

CPU 120 can also be used as a main control center in a vehicle to implement vehicle operation function, and get corresponding vehicle-driving information. USB, RS232 and 1394 as well as each kind of communication interface can be used as I/O interface for communication between CPU 120 and other modules.

The present invention's every module and each device can have multiple redundant modules or devices, the functions of which include: (1) When a device is or multiple devices are damaged, implement lost function of those damaged devices instead them, or on the basis of implementing original functions, increase lost function of those damaged devices; (2) Implement the works with same functions to strengthen those functions; (3) Implement the works with different functions and characters individually. For example, CPU 120 can be a single module or con consist of multiple modules, those multiple modules can be same model and same type or different model and different type, they can carry out same functions or different functions, such as CPU 132 of communication module 130, CPU module 120, CPU module 141 of alarm sensor and vehicle locking module 140, CPU module 161 of GPS poisoning module 160, and CPU module 171 of alarm radar module 170 etc. The CPUs in those modules can carry out their functions of themselves individually, or other functions of lost functions of damaged modules on the same time. In other words, one function can be carried out by one CPU or several CPUs, such as, there may be several CPUs to carry out image receiving, image identification, store and record of each kind of information received from the CPU module individually. Similarly, multiple functions can be carried out only by CPU. Those CPUs can be same model and same type or different model and different type. According to the design requirements, CPU 121 can be each kind and type of CPU, such as PXA800F (development code: Manitoba) processor that integrates CPU, DSP and flash memory and so on, or PXA26X processor and so on. According to the design requirements, each kind of CPU can be used, such as the CPU for desk-top computer, notebook computer, industrial control computer, pocket computer, each type multi-media computer etc.

CPU 120 can also use existing each kind of computer modules with CPU, such as each kind of Personal Digital Asistant (PDA), such as iPAQ H5450 overall computer etc or their partial circuits, or each type of CPU modules or their overall computer. Connection of CPU module 120 with automobile control module 140 and/or each kind of electronic sensors in the vehicle can be used as a main control center in the vehicle. Click the screen of PDA to control the vehicle for carrying out each kind of operation and get corresponding vehicle-driving information.

Computer identification method, such as biological identification method (face identification technique, iris identification, retina identification, fingerprint identification, voice recognition, identification of the shape of a mouth, and handwriting identification, etc) and/or secret codes method such as smart card secret codes input method, keyboard secret codes input method etc can be used to verify the vehicle owner.

We can use one secret codes input method or multiple secret codes input methods. We can also use one set of secret code or multiple sets of secret code, such as self-identification secret code or common deception secret code. The self-identification secret code is real identification secret code of the vehicle owner, and the deception secret code is only the one that deceives the robber. That set of deception secret code has alarm and start functions from vehicle-locking status to start status for deceiving the criminal suspect.

Communication and/or anti-interference communication module 130 includes: RF signal transmitting and receiving module 131 that is controlled by the controller 132, memory 133, voice processor 136 and pickup and speaker 137, coder 134, key-input pad 135 and other devices and circuits. The communication between the communication module 130 and CPU 120 is carried out through I/O circuit. According to the design requirements, each kind of radio network communication system modules or their overall unit can be used, such as, common network equipment: GSM, CDMA system as well as high-speed communication networks, such as 3G, 4G high-speed communication networks to be developed in the future, and satellite communication, or each kind of radio network communication systems, such as “Air Interface for Fixed Broadband Wireless Access Systems” [symbol] IEEE802.XXX [symbol] [symbol] IEEE 802.1XX [symbol] IEEE 802.11X, IEEE 802.16X, IEEE802.2XX, USA Flarion company's Flash-OFDM, Intel company's WIMA, XZig-Bee, Mobile-Fi, [symbol] [symbol] [symbol] [symbol] company's Flash-OFDM radio technology and Ultrawideband and other standard radio network communication systems, or using wireless intercom system, radio station system, such as USA PCC company's (Pacific Crest Corporation) high-speed wireless data transmission radio station EDL and each kind of radio communication system, or using radio anti-interference monitoring communication system and other kinds of anti-interference radio communication and monitoring systems at the same time, and Lanya ( [symbol] [symbol] ) communication system and other wireless communication systems, and wireless communication system modules, such as Siemens company's GSM module AC35-GPRS, GSM module AC35-GPRS and GSM module TC 35—dualband and other kinds of communication modules and overall unit circuits, or Shenzhen Waveguide company's MOP Net (Waveguide) C81X and each kind of built-in or building-out radio network modules that are suitable for notebook computer or desk-top personal computer. C81X uses USB interface, which can carry out GPRS digital communication in GSM network.

The alarm sensor and vehicle control module 140 includes: Central control unit 141 and (dynamic and static) memory 144. The central control unit 141 carries out communication through I/O interface I/P 143 and alarm sensors such as infrared sensor 145, vibration sensor 146, gear lock sensor 147, intermediate control lock sensor 148 and other types of alarm sensors, and through vehicle status sensors, such as, intermediate control lock 149, generator lock 150, alarm speaker 151 and alarm start switch 152 as well as communication module I/O interface I/O 142. The alarm sensor and vehicle status sensing control module 140 can be any known alarm sensor of automobile alarm systems mentioned above for controlling and monitoring the information of automobile-self electronic control system. The central control unit 141 of this alarm sensor and vehicle control module 140, and (dynamic and static) memory 144 share with CPU module 120 through I/O interface I/P 143. The image identification function can be carried out in the alarm sensor and vehicle control module 140, or the image data taken can be sent to the control center by the communication module 130 and processed by the control center's computers. The camera alarm monitor start device can be the existing each kind of sensor, or camera alarm start unit, or initiative/passive infrared alarm device.

GPS positioning module 160 includes GPS receiver 162, GPS micro-processor module (CPU module) 161 and GPS receiving antenna 163 etc. It can be each kind of GPS positioning modules or their overall unit, such as GARMIN G-25lvs GPS, Jupiter 371/381, GARMIN G-25lvs, TFAG 10 and MOTOROLA company's GT or UT, Japan SEIKO's ( [symbol] [symbol] [symbol] ) GPS module “S4E39861” and other GPS positioning modules. The purpose of that arrangement to GPS positioning module is to inform the control center the position of the vehicle when alarming.

Sensing and alarming radar module 170 includes: Radar microprocessor module (CPU module) 171, one or several microwave RF radar distance measurement alarm module 172 and/or one or several ultrasonic distance measurement alarm module and/or infrared distance measurement alarm module 173 etc. Radar module 173 can sense whether or not there is an obstacle outside of the vehicle, its direction, distance from the vehicle, speeds of the vehicle when the vehicle is close to or departs from the obstacle and other information as well as vehicle driving control situations.

Display module 180 includes: panel display 181 such as liquid crystal display (LCD), PDP display, organic light emitting diode display (OLED), and the displays using crystal reflex display (SXRD) technique, DLP display technique and so on.

And/or head up display (HUD) 182. Its lighting part includes: liquid crystal head up display, penetration type organic light emitting diode (OLED) head up display, and the head up displays using crystal reflex display (SXRD) technique, DLP display technique and each kind of head up displays. The head up display can be: a head up display with full figure spectroscope display, or the head up display using general car window glass as the display like General company and so on. The circuit part and display part of the CPU module 120 can be placed in different positions in the vehicle individually, or made together as a whole. The display part can be connected with CPU module 120 through wire or wireless method.

The panel display 181 in the display module 180 and/or multi-function head up display system can display each item of display contents required by the design and pre-assigned by the user, including:

(1) Displaying selected each kind of parameters collected by CPU module 120 before or when running, and displaying vehicle measurement process and results before starting, such as reading in each kind of information in USA California's OBD-II (ON-BOARD DIAGNOSITICS-II) standard. A vehicle electric control system tested by a computer test system includes: Reading out control unit version (01); reading out trouble codes (02); executive component diagnostics (03); basic settings (04); Cleaning trouble codes (05); finishing test outputs (06); control unit codes (07); reading measurement data block (08); reading single item datum (09); match adjustment (10); sign on (11); ready code status (15); and each item of display contents required by the design and pre-assigned by the user.

(2) Multi-function head up display system that consists of a head up display and camera devices. Those camera devices are mounted inside or outside the vehicle and take pictures from different directions. The head up display can display selected images token by visible light, low-light and/or infrared, thermo-luminous infrared camera devices and/or numerical code camera devices, acting as a noctovisor, side-looking/back-looking mirror, and the driver has no need to turn his/her head for watching the conditions at the both sides and the back of the vehicle, so as to reduce traffic accidents.

(3) It is possible to use visible light, low-light and/or infrared, thermo-luminous infrared camera devices and/or numerical code camera devices 5g, 5a and 5b etc at the front, both sides and back of the vehicle to take images at dark night so that the driver's visual field at night is widened, so as to reduce traffic accidents.

(4) Each kind of valuable information can be displayed, such as electronic map of GPS (Global Positioning System), automobile driving control information and the contents that can be displayed on each kind of display.

A forward-looking and/or back-looking and side-looking head up display system consists of visible light, low-light and/or infrared, thermo-luminous infrared camera devices and/or numerical code camera devices with orientations of the front, both sides and back directions set up inside and outside the vehicle.

In order to explain conveniently, in real design and manufacture, each circuit and device of each functional module in the present invention's attached figures can be increased or decreased according to the design requirements. For example, the present invention's basic and requisite modules include: camera (and/or numerical code camera) and/or voice receiving module 110, CPU 120 and communication module 130 etc, other modules can be increased or decreased according to the design requirements, such as alarm sensor and vehicle control module 140, GPS poisoning module 160, and each part's functional control modules such as generator control and brake control module, each display control module and so on. In addition, redundant parts and/or redundant functional modules can be used in the present invention's burglar circuit design. When partial circuits are managed, other redundant modules can continue carrying their functions. For example, there will be placed multiple GPS antenna or communication antenna individually, there will be placed multiple communication modules individually, and there will be placed multiple CPU modules individually and so on. Therefore, if one or several modules are destroyed, the alarm information will be still sent out on time, and if one or more camera devices are destroyed, the remaining will take images of the criminal suspect for alarming. It is possible to integrate each function of CPUs in each module and only one CPU is used for processing all the functions. It is possible to re-combine camera (and/or numerical code camera) and/or voice receiving module 110, communication module 130, CPU 120, alarm sensor and vehicle locking module 140, GPS poisoning module 160 and so on in a new module or to change their functions, or to reduce the number of CPUs, or that each CPU of each module is the redundant CPU of other functional module. It will be better to use multiple CPUs in multiple modules so that each CPU of each module is the redundant CPU of other functional module, if one module or several modules or one CPU or several CPUs would be destroyed, the remaining could carry out their functions. Because the criminal suspect can't destroy all the modules, antennas or camera devices at a moment, there a time difference before the system is destroyed and after the system has been destroyed, each kind of image and data information for a burst event are transmitted to a remote monitor and control center for alarming on time through redundant modules or devices.

The present invention's each type of modules in each kind of modules can be multiple modules with same functions and/or multiple modules with different functions. Those modules can be used as parallel processing modules, or the ones with different functions such as CPU module.

An automotive storage battery can be used directly as the power source for the present invention's automobile safety defense and alarm system, the battery is a standby power source, connecting with other power sources through power cables. In general, an external power source supplies power to the automobile safety defense and alarm system, and charge the battery, at the same time, the host machine will monitor the external power source at any time. When it is monitored that the external power source is interrupted, the power supply will be changed to the battery and the alarm circuit will be started. According to design requirements, a power test circuit can be added in the power module to monitor the power supply. According to different power supply conditions, use different circuits, for example, when driving or when an emergence is happening, all the power supplies may be used for power supplying. When only the monitor function will be carried out, or when the storage battery is interrupted, it may be possible to supply electricity to partial circuits.

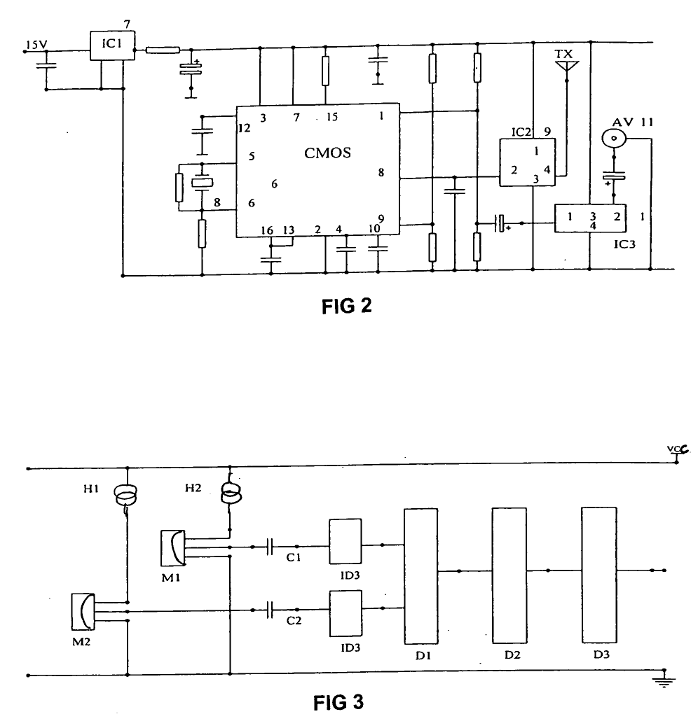

FIG. 2 is the present invention's circuit diagram of camera part.

In the FIG. 2, CMOS image sensor 6 (such as FUB06 image sensor), through the camera, receives optical signals and change them to electrical signals, and then send those electrical signals to an output interface circuit IC2 and then to CPU module 120. According to design requirements, the interface circuit can be USB interface circuit or other interface circuits. USB interface circuit SHARP single chip controller (LR38873) that is suitable for USB On-The-Go 1.0 standard, or for USB1.1, USB2.0, 1394 standards or other chips. The electric signal from CMOS image sensor 6 will be also sent to the image output amplifier IC3 (Model FUB30) for amplifying, and then sent to AV output processor 10 for processing, and finally standard AV signals are output. According to design requirements, the power supply voltage stabilizing circuit 7 (Model AD7812) can be changed for supplying overall circuits. The crystal oscillator 8 will provide clock signals to the CMOS image sensor 6.

FIG. 3 is the present invention's circuit diagram of thermo-luminous electric infrared sensor for temperature difference alarm.

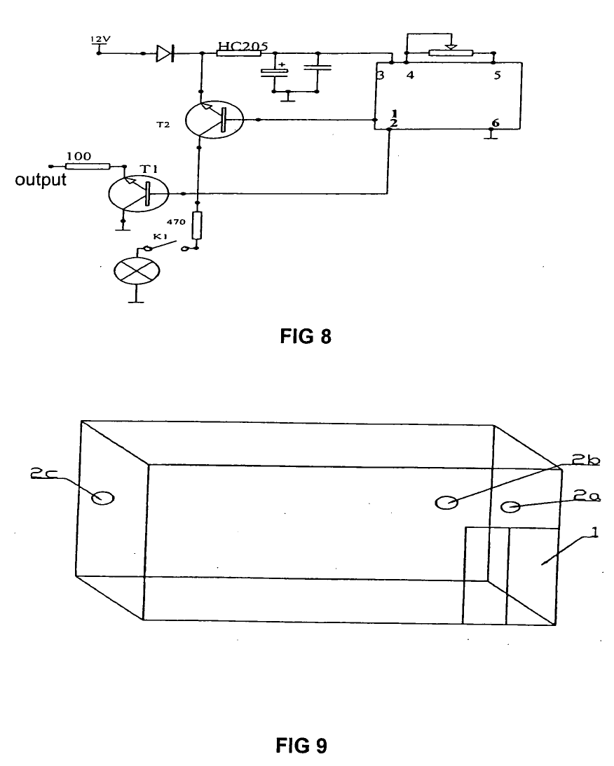

FIG. 3 explains a kind of thermo-luminous electric infrared sensor circuit for temperature difference alarm, which consists of passive infrared sensor monitor (such as the passive infrared sensor monitor that consists of pyroelectricdetectors 2288 or 2613 series thermo-luminous electric infrared sensors. Two thermo-luminous electric infrared sensors can be used as a balance circuit, in which one is used to close the entrance windows so as to cancel the influence from the change of temperature in the vehicle), A/D converter circuit, CPU for calculation of common-mode rejection, and D/A converter circuit. Connect thermo-luminous electric infrared sensors M1 and M2 to capacities C1 and C2 individually. According to the requirements, input the voice signal grabbed to pre-processing circuits ID₂ and ID₁, then through A/D converter circuit D₁ to a digital signal processing circuit D₂ for thermo-luminous infrared temperature difference calculation. In the process of that temperature difference calculation, cancel the common-mode signal and select difference mode signal, measure out the change of the signal resulted from the temperature difference between the temperature of the person who goes into the vehicle and the environmental temperature in the vehicle (If the real temperature in the vehicle can be measured out, according to the real temperature difference, the real body temperature of the person can be available). Through interface circuit D₃, the digital signal processing circuit D₂ outputs alarm information or temperature signal value, and/or the measured temperature of the person or a part of the person. The digital signal processing circuit can also consist of other type of digital circuits or other kinds of thermo-luminous electric infrared alarm sensor circuits. The thermo-luminous electric infrared detector circuit of thermo-luminous electric infrared detector module HN911Lshown in FIG. 8 uses a thermo-luminous electric infrared sensor to receive the infrared energy from the human body and then processes the infrared signal received with electric circuit and send alarm information. It has high sensitivity and wide detecting range and is easy to operate.

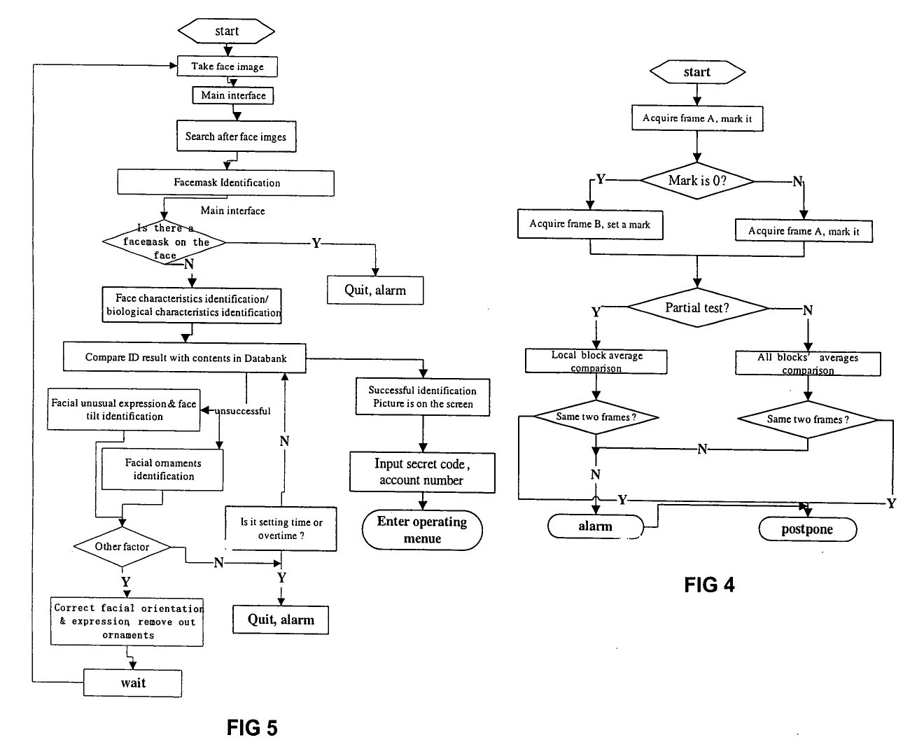

FIG. 4 is the present invention's block diagram of system program to make a dynamic monitoring of the conditions in a vehicle with camera devices.

As shown in FIG. 4, the system program method for dynamic monitoring the conditions in the vehicle with the camera devices for automobile burglar alarm includes the following processing processes: camera device (and/or digital camera devices) and/or sound-receiving module 110 will process the image signals and/or voice signals taken by camera lens 111 and sensitive elements and make a signal processing to the video frequency and audio frequency output signals. After signal processing, the processed signals will be as output analog or digital signals and through an output interface output to the CPU module 120 and then CPU 121 will make a video frequency monitoring processing by means of digital image frame processing technique and/or brightness gobo testing method.

Its processing process is: Firstly, acquire frame A and inspect whether or not it is marked. If it is marked, regard it as Frame B, then re-acquire frame A. Frame A has no the marks. Make a local comparison between Frame A and Frame B. That local comparison may be a local block average comparison or a comparison of all the blocks' averages comparison. Inspect whether or not frame A is the same as frame B. If both frames are same, continue acquiring frame A. If both frames are not same, go to the alarm program.

Practically, camera devices, CPU module and dynamic control system program form a camera dynamic monitor and control system.

FIG. 5 is the present invention's block diagram of system program about photographing, face identification and alarm system.

The principle and processing method of camera, face identification and alarm system program for automobile burglar alarm include the following processing process: camera device (and/or digital camera devices) and/or sound-receiving module 110 will process the image signals and/or voice signals taken by camera lens 111 and sensitive elements and make a signal processing to the video frequency and audio frequency output signals. After signal processing, the processed signals will be output analog or digital signals through an output interface to the CPU module 120 and then CPU 121 will confirm whether or not the driver is a legal one by means of image identification system program.

This system includes “Mask identification subprogram”, and/or “Facial characteristics and/or biological characteristics identification subprogram” and/or “Face tilt identification subprogram” and/or “Facial ornaments identification subprogram” and/or “Facial unusual expression identification subprogram” and/or “facemask identification subprogram”, from which one subprogram or several subprograms can be used according to the design requirements.

Its processing procedure is: Firstly, acquire image data with camera devices. According to the design requirements, the camera devices can be visible light, low-light and/or infrared, thermo-luminous infrared camera devices and/or numerical code camera devices, or a combination device of two or more camera devices mentioned above. Face identification and/or each kind of biological characteristic identification will be carried out to those received face images or biological characteristic images. The biological characteristic identification includes iris identification, retina identification, fingerprint identification, voice recognition, identification of the shape of a mouth, and handwriting identification, special action identification. After that, the identity recognition will be done. Make a comparison between the face image characteristics and/or his/her biological image characteristics to be verified and the face image characteristics and/or his/her biological image characteristics stored in the biological characteristics databank of legal drivers to confirm whether or not the driver is a legal one. If the “Facial characteristics and/or biological characteristics identification subprogram” is not able to verify whether or not the driver is a legal one, then use “Face tilt identification subprogram” and/or “Facial ornaments identification subprogram” and/or “Facial unusual expression identification subprogram” to make the identification.

According to the design requirements, make face identification with “Facial unusual expression identification subprogram” and “Face tilt identification subprogram”. If the unusual expression of the person in the vehicle is found out, and/or his/her faces are not directed at the camera, then a prompt will be sent to ask that the person should immediately correct his/her facial unusual expression and should be directed at the camera. Then, make a comparison between the face image characteristics and/or his/her biological image characteristics to be verified and the face image characteristics and/or his/her biological image characteristics stored in the biological characteristics databank of legal drivers to confirm whether or not the driver is a legal one. If the “Facial characteristics and/or biological characteristics identification subprogram” is still not able to verify whether or not the driver is a legal one, then carry out “Facemask identification subprogram” and “Facial ornaments identification subprogram”.

According to the design requirements, carry out “Facemask identification subprogram”. If it is found that the person in the vehicle wears a facemask, then enter into the alarm program. If it is not found that the person in the vehicle wears a facemask, then enter into the “Facial ornaments identification subprogram”.

During the period of carrying out the “Facial ornaments identification subprogram”, if it is found that the person in the vehicle wears ornaments, or a confirmation to verify whether or not the driver is a legal one can not be made after making a comparison between the face image characteristics and/or his/her biological image characteristics to be verified and the face image characteristics and/or his/her biological image characteristics stored in the biological characteristics databank of legal drivers (or before that comparison program is carried out), provide a prompt to the driver, asking him/her to remove out his/her ornaments, retake his/her face image for re-carrying out face identification and remaking a comparison. If the driver is found out as a legal one, then ask the diver to wear his/her ornaments on, retake his/her face image data and store them (or the face characteristics data of the driver with the facemask taken before) in the biological characteristics databank of legal drivers as that driver's new face characteristics data. If the driver is found out as an illegal driver, make an alarm processing.

If the face characteristics of a legal driver are successively obtained, the legal driver's image will be displayed on the display or the legal driver will be required to input other identification method such as fingerprint identification, iris identification, retina identification, secret code input recognition, and handwriting identification, etc. It is possible to select one method or multiple methods from those identifications to carry out further identification synchronously or non-synchronously. That step can be neglected and for example directly entering operating system program. If it is found not to be in conformity with the face characteristics of legal driver after comparing, in order to avoid incorrect identification, make an other identification again or multiple identifications. After confirming there is no incorrect identification, start alarm control system program for alarming.

The biological characteristics identification databank stores specially designated persons' face characteristics data and/or biological characteristic identification data, such as the data for iris identification, retina identification, fingerprint identification, voice recognition, identification of the shape of a mouth, and handwriting identification, special action identification and so on. Besides, this databank also stores other kind of data, for example, animal's characteristics (be used for animal identification to judge whether or not it is an animal and which kind of animal it is), or specially designated persons' characteristics data that may be used in other biological characteristic identification system or each kind of the data related to face characteristic identification.

Practically, camera devices, CPU module, “Facial characteristics and/or biological characteristics identification subprogram” and the biological characteristics identification databank form a facial characteristics and/or biological characteristics identification system.

Physiological characteristics safety software on face, voice and lip action characteristics such as BioID2.1Client/server etc can be also used for identification use.

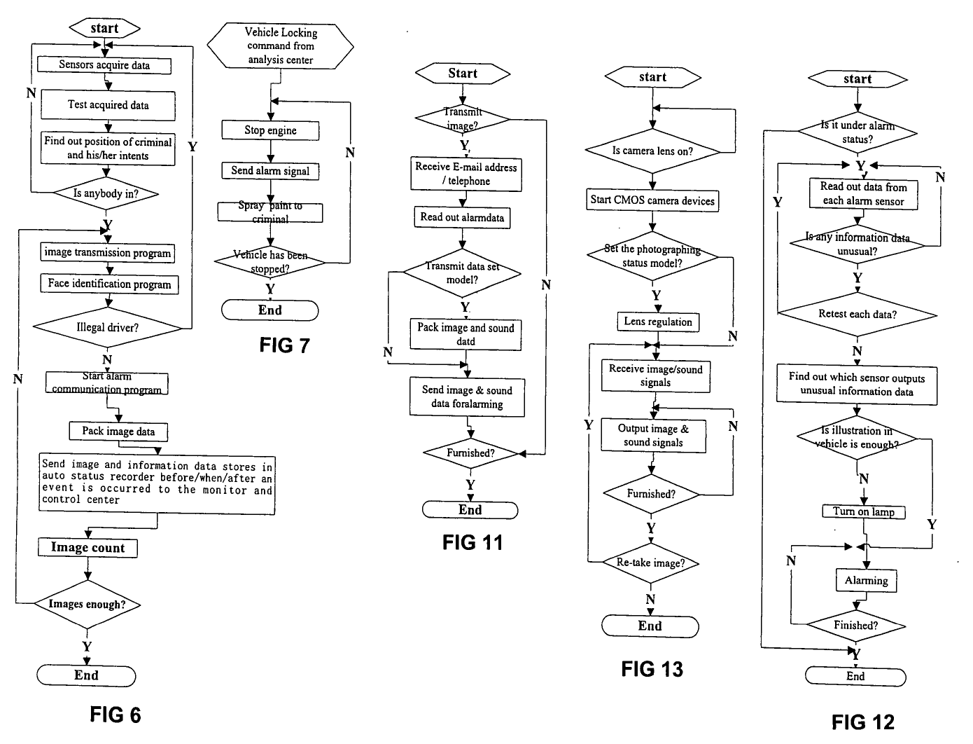

FIG. 6 is the present invention's block diagram of main system program about automobile alarm system.

The processing for automobile burglar alarm (or for other applications purposes, such as used in office, bank, building, warehouse, home, yard etc. In this manual taking office as an example) includes the following steps: Using alarm and monitor sensor, radio communication module, pickup, CPU module, single or multiple camera devices, after the vehicle or office is under the condition of monitoring, when somebody or an animal attempts to enter into or destroy the vehicle or has entered into the vehicle (or the office), the alarm and monitor sensor will send an alarming signal to start the alarm system program. At that moment, a program for re-checking each sensor can be carried out to confirm whether or not somebody or an animal attempts to enter into the vehicle or has entered into the vehicle (or the office), or a program for re-checking each sensor can be carried out to confirm whether or not somebody attempts to destroy the vehicle or has entered into the vehicle (or the office) and his/her position in the vehicle. According to a preset program and present position and other information, make a judgment on his/her intention of crime and carry out different alarm programs. For example, using the camera devices image-taking and image transmitting program to send the images to CPU module; Using the face identification system program and the specially designated persons' face characteristics databank to verify whether or not the person who wants to enter or destroy the vehicle is a legal driver or office worker, if the person is found as illegal driver, then make a judgment that it is an animal and what kind of animal it is and then using the camera devices image-taking and image transmitting program to send the images to CPU module; Starting alarm and communication system program to send the data on face image of the person who has entered into and wants to destroy the vehicle, and/or the images and information stored in the automobile status recorder (Black box for automobile use) captured before a burst event is happened and/or when the burst event is being happened and/or after the burst event has happened; and/or the information collected inside and outside the vehicle (packing or non-packing the image data according to each packing protocol for the image transmission) and the voice data or packed image and voice data and other automobile status information and preset each kind of information to a preset remote or short-distance monitor and control center for alarming; Starting the burglar control system program and implementing the commands from the vehicle (or the office) and/or preset burglar measures to carry out vehicle (or office) burglar control. At the same time, a sound, optical or electrical alarm will be made, for example, flash lamp and alarm whistle and so on.

The processing method for automobile burglar alarm (or other object burglar alarm) and the processing method for anti-robbing alarm can use a same program procedure, but the starting point of the program procedure. The processing method for automobile burglar alarm decreases the following steps: When somebody attempts to enter into or has entered into the vehicle, the alarm sensor will send a alarm signal, start the alarm system program, and at that time, a program for re-checking each sensor can be carried out to confirm whether or not somebody attempts to enter into the vehicle or has entered into the vehicle, then start the alarm system program. Those decreased steps are changed as that the vehicle starts or start the alarm system program at a fixed time after starting. Therefore, the processing method for anti-robbing alarm (or other object anti-robbing alarm) includes the following steps: When or after starting a vehicle, using the alarm and monitor sensor, radio communication module, pickup and CPU module and camera devices to start the alarm system program; Running the program to verify from where the person attempts to enter the vehicle; Starting the camera devices image-taking and image transmitting program to send the images to CPU module; Using the face identification system program and the specially designated persons' face characteristics databank to verify whether or not the person who wants to enter or destroy the vehicle is a legal driver. If the person is found as illegal driver, start the alarm and communication system program to collect the data on face image of the person who has entered the vehicle and/or the images and information in the vehicle captured by the camera devices, after packing or non-packing the image data according to each packing protocol for the image transmission, and then transmitting those image and voice data or packed image and voice data and other automobile status information and preset each kind of information to a preset remote monitor and control center for alarming; Starting the burglar and anti-robbing control system program and implementing the commands from the vehicle and/or preset burglar and anti-robbing measures to carry out vehicle burglar and anti-robbing control.

As shown in FIG. 1, the alarm sensor and vehicle control module 140 carry out the monitoring program to monitor who goes to the vehicle, the camera device (and/or digital camera devices) and/or sound-receiving module 110 will process the image signals and/or voice signals taken by camera lens 111 and sensitive elements and make a signal processing to the video frequency and audio frequency output signals. After signal processing, the processed signals will be as output as analog or digital signals and through an output interface output to the CPU module 120 and then CPU 121 will use a face identification system program to monitor whether or not the driver is legal one. The alarm sensor and vehicle control module 140 carries out automobile burglar and anti-robbing control function and the communication module 130 will send alarm information to the alarm center.

FIG. 7 is the present invention's block diagram of system program about burglar brake control system.

As shown in attached figure, the automobile burglar and anti-robbing control for automobile burglar alarm includes the following processing procedure: After the vehicle is under the alarm condition, according to the vehicle-locking command from the analysis center (or the monitor and control center or the CPU module 120), the CPU in the alarm sensor and vehicle control module 140 (or in the CPU module 120 or in other modules) may carry out each burglar program, such as locking the vehicle, stopping the generator, sending the alarm signals as well as spraying paint to the criminal suspect, stopping the vehicle running and so on.

FIG. 9 is the present invention's floor plan of camera devices and alarm sensors.

The present invention can be used in any places where there are needed that safety alarms, such as bank, building, office, warehouse, home etc as well as each kind of vehicles, ships, air planes and so on for safety, monitoring and alarming. In addition, the present invention can also be used as a safety alarm for instrument, equipment or other valuables. As shown in attached figure, when it is used as an indoor safety defense and alarm system, the camera devices can be placed in the wall 2b corresponding to the door 1 or at other positions, such as 2a and 2c in the walls at other two sides, of course, camera lens is directed at the room. The alarm sensors can be put on both sides of the camera device or other positions.

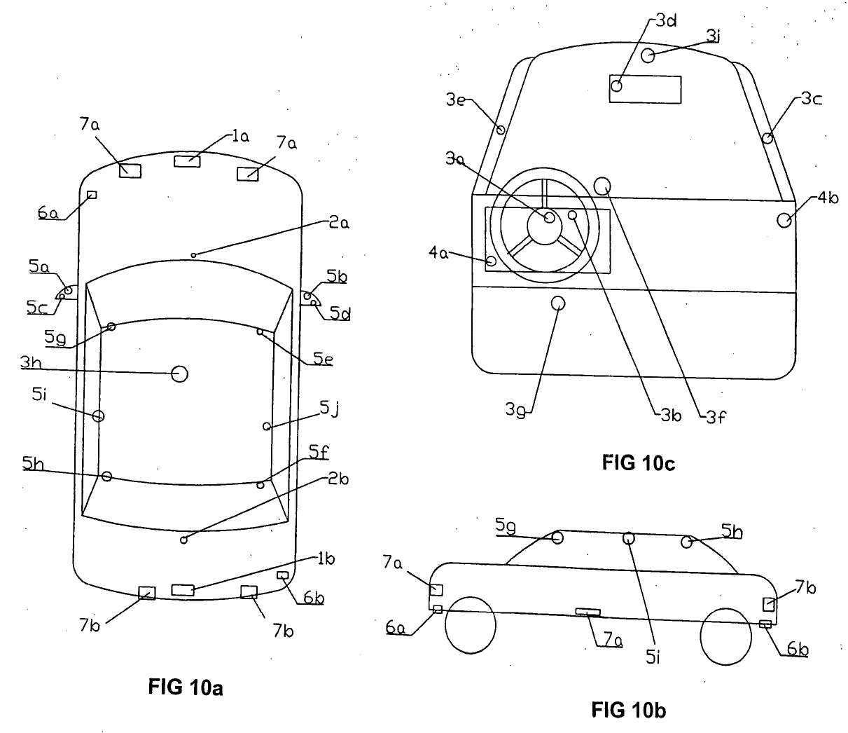

FIG. 10 is the present invention's position figure of antenna, camera devices and sensors in the vehicle. FIG. 10a, FIG. 10b and FIG. 10c are top view and side view of a vehicle and section view of instrument panel in the driver's cab individually.

As shown in attached figure, set up each device or part at any position you need according to design requirements. For example, the present invention's camera devices can be set up at any position in the vehicle such as on the instrument board, in the lamp, on the back of the pilot set, above the steering wheel and or other places such as in the machine in the machine chamber at the vehicle head and/or in the cargo container, and/or in the back-looking mirrors at both sides of the vehicle, and/or under the chassis etc. When somebody opens the machine chamber cover at the vehicle head, and/or the cargo container cover and/or destroys the external surface of the vehicle, the machine in the machine chamber, and/or GPS antenna or radio communication antenna in the cargo container, and/or the burglar camera alarm module or other modules in the cargo container, each kind of burglar sensors will sense that destroying action and start the camera devices to capture the destroyer's image at the first time. If a partial functional are destroyed, an alarm will be still made out through redundant antenna and/or modules. The camera devices can be set up at any direction of the pilot set such as tits front, back, both sides, right upper, right lower, left upper, left lower of the pilot set, so that the camera devices can capture the images of the criminal suspect from different directions. The camera devices can be arranged in obvious or concealed manner. The obvious camera devices will have the function to throw a scare to the criminal suspect and the concealed camera devices can protect themselves to be destroyed. The transmission of the image data between each camera device and the CPU module 120 can be done through cable or wireless communication. Wireless communication can be radio or infrared communication in order to protect the CPU module 120 and other devices/modules from finding out and destroying when the criminal suspect finds out the camera device.

(a) Single (or a set of) antenna or multiple (or multiple sets of) antennas (GPS receiving antenna and/or radio receiving antenna) 1a and 1b are set up individually in the front of the machine chamber and in the rear of the cargo container, or other positions in obvious or concealed manner according to the design requirements. All the antennas should be set up at such place where in the front directions of the antennas there should be no metal shielded objections that will have influence on receiving or transmitting the radio waves for communication with the outside. Multiple (or multiple sets of) antennas (GPS receiving antenna and/or radio receiving antenna) may be used as redundant antenna to protect them from destroying.

(b) Camera devices 2a and 2b are set up individually in the front of the machine chamber and in the rear of the cargo container, acting as anti-destroying camera devices. When somebody opens the machine chamber cover at the vehicle head, and/or the cargo container cover, the anti-destroying sensors will start visible light, low-light and/or infrared, thermo-luminous infrared camera devices 2a and 2b to capture the images of the person who opens the machine chamber cover and/or the cargo container cover, and send an alarm information through the redundant antenna or modules at other places. The alarm sensors near to the antenna can take picture of the person who attempts to destroy the antenna and monitor the person when he/she is going close to the antenna.

(c) The thermo-luminous infrared temperature difference alarm sensor 4a and/or 4b can be set up individually at the position in the vehicle such as in the instrument board and/or the front panel board where the sensor can be easy to sense that somebody is entering into the vehicle.

(d) With respect of concealed camera devices 3a, 3b, 3c, 3d, 3e and 3g etc, the visible light, low-light and/or infrared, thermo-luminous infrared camera devices 3b can be set up in the instrument board, the camera device 3a can be set on the steering wheel, the camera device 3d can be set on the back of reflection mirror for the driver use, the camera device 3e, 3c and other sensors can be set on the posts A, B, C and so on.

(e) A camera device and/or multiple camera devices of the present invention set at inside and outside the vehicle has/have its/their orientation of outward vehicle and is/are used to capture the images of the person who attempts to steal/destroy the vehicle, for example, camera devices 3h and 3i can be set up in the lamp cover as anti-destroying camera device, camera devices 5a, 5b, 5c, and 5d can be set up in the back-looking mirror covers with orientations of the front, rear, left and right directions of the vehicle individually; camera devices 5e, 5f, 5g, 5h, 5i, 5j can be set up in the front and rear vehicle windows or at the positions above or beneath the front and rear vehicle windows with image-taking orientations of toward the head, back and both sides individually. Camera devices 6a and 6b can be set under the chassis. In general, the lens covers cover them, only after the burglar and anti-robbing alarm system is started or after the alarm sensor 7a under the chassis is triggered, the covers are then opened to start devices 6a and 6b for taking pictures. Vehicle radio radar RF module and/or ultrasonic module for ultrasonic radar 7a and 7b are set up at the front and rear of the vehicle with orientation of forward or backward individually or set up at each part outside the vehicle with same or different orientation.

(f) Camera device 3g can also be set up under the instrument board as a anti-destroying camera device, around which there can be set up anti-destroying alarm sensor for monitoring it. Similarly, around main modules of the present invention's automobile safety defense and alarm system there can be also set up the anti-destroying camera devices and anti-destroying alarm sensors for monitoring them. The camera device can be set up at obvious position, as shown in the figure, the position of the front panel board the camera device 3f is set up. The present invention's automobile safety defense and alarm system can be equipped with a camera device or multiple camera devices. Multiple camera devices can be acted as the redundant devices to protect such condition from happening that one or several camera devices are destroyed and in addition, can take pictures of the person in the vehicle from different angles to increase the picture's clarity. The quantity of the camera devices and their positions can be decided according to the design requirements. Multiple antennas can either act as redundant antenna, or take pictures of the person in the vehicle from different angles. The quantity of the camera devices and the alarm sensors, and their positions and orientations can be increase, decreased or changed according to the design requirements. The camera devices may be equipped with corresponding visible light and/or infrared illuminations, so as to make-up the illumination when it is not enough. The quantity of the present invention's every devices/modules, their positions, types and kinds can be increase, decreased or changed according to the design requirements.

FIG. 11 is the present invention's block diagram of radio alarming communication system.

As shown in attached figure, the processing method for automobile alarm communication and control includes the following processing procedures: The CPU module 120 runs the face identification system program to verify whether or not the person in the vehicle is a legal driver. If the person in the vehicle is found to be an illegal driver, start radio alarm communication program and inspect whether or not the alarm information is sent. After confirming, call out receipt e-mail address and/or monitor and control network address and/or alarm telephone number, connect them to the remote control center, read out all the preset data for alarming that may include: the image data and information taken when the burst event is happened, the image data and information in the automobile status recorder (black box for automobile use) taken before the burst event is happened, and other information. Pack the image data to be transmitted according to each packing protocol for the image transmission and then transmit packed alarm information and packed image and voice data and other automobile status information and preset each kind of information to a portable equipment such as a mobile telephone through a radio or cable communication system, E-mail, and/or a monitor and control network station, and/or alarm telephone. After communication, complete the program running.

Packing the image data, voice data and other data and information to be transmitted according to preset communication protocol can be done by the communication module 130, or the image taking (and/or numerical image taking) and/or sound receiving module 110, or the CPU module 130 so that the alarm data to be read out may be pre-packed and processed data.

It is possible that firstly pack the image data, voice data and other data and information to be transmitted according to preset communication protocol, then call out receipt e-mail address and/or monitor and control network address and/or alarm telephone number, connect them to the remote control center,

If it is not necessary to pack the image data, voice data and other data and information to be transmitted according to preset communication protocol, then each kind of data can be directly transmitted out.

FIG. 12 is the present invention's block diagram of automobile monitoring system.

The principle and processing method of automobile monitoring and processing of the present invention's automobile safety defense and alarm system includes the following procedures: After the vehicle is under the condition of monitoring, start the alarm detection system program; Checking whether the vehicle is under the condition of monitoring, after confirmation, read out the data of each sensor firstly and make a comparison to find out whether those data are correct; If incorrect data are found out, find out which sensor sent those incorrect data and its position and orientation, so as to find out from which position and how the person goes into the vehicle; Inspecting the illumination in the vehicle, turn on the infrared/illuminating lamp if the illumination is lower the preset value; and starting the alarm program. Finally, confirm the alarm program is completed and the automobile monitoring system program is finished or the vehicle continues to be under the condition of monitoring.

FIG. 13 is the present invention's block diagram of photographing and image transmitting system.

The processing method of photographing and image transmitting of the present invention's automobile safety defense and alarm system includes the following procedures: When the automobile monitoring system program confirms somebody has entered into the vehicle according to the unusual data from each sensor, start the photographing and image transmitting program; Firstly, turn on the power supplies for each camera device module, start CMOS camera device (or CCD camera device or other type of camera devices), and adjust the status setting model of those camera devices, such as data input model, camera light ring and sensitivity setting, and sound-receiving sensitivity setting and other parameters; Then take picture/image and receive the voice signal, and output image and voice signals; Finally, according to the preset requirements, carry out the photographing and image transmitting program again.

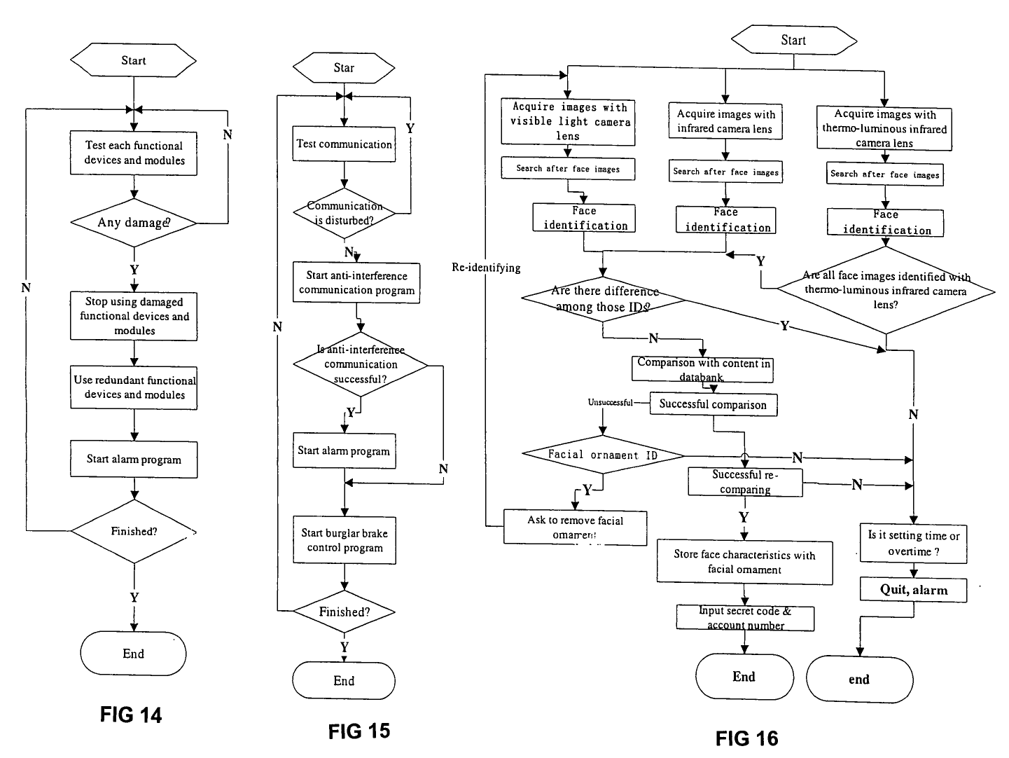

FIG. 14 is the present invention's block diagram of automobile redundant monitoring system.

The present invention's anti-destroying and anti-interference system includes: (1) the processing method for redundant monitoring to the redundant devices and/or redundant functional modules and the automobile burglar alarm. (2) the processing method for monitoring of redundant communication system, anti-interference communication system and anti-destroying communication detection system.

The processing method for redundant monitoring to automobile burglar alarm includes the following procedures: Running the redundant monitoring system program; firstly, test the performance of each functional device and each functional module; If it is found out that a functional device and a functional module is damaged, separate it and start preset replaced device/module instead of it and at the same time, start the alarm system program to take picture, make face identification and send alarm signal.

FIG. 15 is the present invention's block diagram of automobile anti-interference communication monitoring system.

The principle and processing method of a kind of automobile anti-interference communication system includes the following steps: Using radio communication module, pickup and CPU module and the CPU for vehicle alarm start the automobile anti-interference communication detection system program to check the communication information for interference; In the case that the communication is disturbed, stating the automobile anti-interference communication system program to make communication without interference with the remote monitor and control center; After that, starting the alarm system program to send alarm signal and/or starting the alarm and vehicle-locking program to lock the vehicle, stop the generator, make acoustic-optic alarm, capture and store the image data of the criminal suspect and so on. If the remote monitor and control center finds out the communication is disturbed seriously, immediately start the alarm system program and find out the interference source and confirm whether it is a man-made interference, otherwise, inform the monitor workers that the communication has been disturbed seriously and take steps to find out the vehicle.

FIG. 16 is the present invention's automobile monitoring program block diagram of the identification of a driver with facemask or face ornaments by means of camera devices.

The setting and processing method for the face identification system, which consists of visible light, low-light and/or infrared, thermo-luminous infrared camera devices and/or numerical code camera devices that take the pictures inside and outside the vehicle and the face identification system software with the functions to identify whether or not the driver and other peoples have face masks or face ornaments, and whether or not their faces are directed at the camera, includes:

(1) Visible light, low-light and/or infrared, thermo-luminous infrared camera devices and photograph devices and/or numerical code camera devices.

(2) A monitor processing method to verify whether or not the driver wears face masks or face ornaments. That monitor method includes “Facemask identification system program”, and/or “Facial characteristics and/or biological characteristics identification system program” and/or “Facial ornaments identification system program”.

(3) In order to increase the identification precision, a “Face tilt identification subprogram” is added.

This method can be used not only to verify whether or not the driver wears face masks or face ornaments that will have influence on identification of the face, but also to test each kind of materials, equipment and/or objects, animals or plants, for example, use this method for fingerprint identification to avoid that somebody may use man-made fingerprint model to deceive fingerprint tester. This method can be used for each kind of the objects testing.

According to the design requirements, this system can use all the camera devices and all the subprograms as a new application system, or use partial camera devices and partial subprograms as a new application system, for example, using visible light, low-light and/or infrared, thermo-luminous infrared camera devices and/or numerical code camera devices and “Facemask identification system subprogram”, “Facial characteristics and biological characteristics identification system subprogram” and “Facial ornaments identification system subprogram” and “Facial unusual expression identification system subprogram” to form a new application system on facial characteristics.

The factors that will have influence on face identification include: (1) The obstructer wearing on the face; (2) The face is tilt; (3) Facial unusual expression. The obstructer may be glasses, breathing mask, or scarf and so on.

The principle and processing method of “Facemask identification subprogram”

1) There are 3 kinds of method to confirm whether or not the driver and other peoples have face masks:

(A) The person wears a facemask that can transmit the visible light and infrared or the person doesn't wear facemask. In that case, visible light, low-light camera devices and infrared, thermo-luminous infrared camera devices (and thermo-luminous infrared sensing and monitoring devices) can take same real face images of that person.

(B) The person wears a facemask that can transmit infrared but the visible light. Therefore, the visible light camera devices may take only the images of the facemask, and the infrared, thermo-luminous infrared camera devices (and thermo-luminous infrared sensing and monitoring devices) can take the real face images of that person. The face characteristics taken by three kinds of camera devices are not the same.

(C) The person wears a facemask that can't transmit both of visible light and infrared. Therefore, visible light, low-light camera devices and infrared, thermo-luminous infrared camera devices (and thermo-luminous infrared sensing and monitoring devices) may take only the images of the facemask but the person. The face characteristics taken by three kinds of camera devices are not the same.

At that time, run the “Face characteristics identification and comparison system program” and “Facemask identification and monitoring system program” to differentiate whether or not the person wears a facemask and which kind it is.

2) The basic principle of “Facial ornaments identification system subprogram” is: With the facial ornaments, glasses, breathing mask, or scarf and so on, the above-mentioned three photographing situation may be happened. At that time, the “Facial ornaments identification system subprogram” should be run to confirm whether or not the driver wears facial ornaments and provide a prompt to the driver, asking him/her to remove out his/her ornaments, retake his/her face image for re-carrying out the “Facial ornaments identification system subprogram”. In the case after the voice prompt is provided, the criminal suspect escapes from the scene of crime, it is unable to take his/her images. At that time, we can wait a moment, then run a preset treatment measures, for example, sending out his/her images taken before or reporting to the police and so on.

The processing procedures of “Facial ornaments identification system subprogram” include: the following processing processes: camera device (and/or digital camera devices) and/or sound-receiving module 110 will process the image signals and/or voice signals taken by camera lens 111 and sensitive elements individually and make a signal processing to the video frequency and audio frequency output signals. After signal processing, the processed signals will be as output analog or digital signals and through an output interface output to the CPU module 120 and then CPU 121 will run a monitoring processing program to confirm whether or not the driver wears facial ornaments by means of the image identification system program.

During a vehicle is running, the driver may be in a situation among the following situations:

a. The driver doesn't wear facemask, facial ornaments;

b. The driver wears facial ornaments, such as glasses, breathing mask, or scarf and so on;

c. The driver doesn't wear facemask that can transmit infrared;

d. The driver doesn't wear facemask that can transmit partial infrared;

e. The driver doesn't wear facemask that can't transmit infrared;

For the treatment procedures please refer to the flow chart FIG. 16. The overall processing procedure is:

First of all, acquire the visible light and/or infrared images taken by the visible light, low-light and/or infrared camera devices and the thermo-luminous infrared images taken by the thermo-luminous infrared camera devices individually and then make a face identification processing to the face images data in those two kinds of image data individually, and finally compare those two kinds of image data in the face characteristics each other and differentiate among them each other. As shown in FIG. 16, steps 1-3 adjust whether or not the driver wears facemask, and step 4 adjusts whether or not the driver wears face ornaments.

Step1: (a) With the visible light and/or infrared images taken by the visible light, low-light and/or infrared camera devices and the thermo-luminous infrared images taken by the thermo-luminous infrared camera devices, through a face identification processing to the face images data in those two kinds of image data made by the face characteristics identification system program individually, confirm that those images are the ones of the same person. In addition, the thermo-luminous infrared camera devices and/or the thermo-luminous electrical infrared sensing monitors sense normal infrared radiation from the face skin, which indicates the situation of (a) or (b).

(b) In the situation (a), compare with the face image characteristics of legal driver in the biological identification characteristics databank. If the person in the vehicle is a legal driver, enter into the sequential program. If the person in the vehicle is an illegal driver, then run “Facial ornaments identification system subprogram”, “Face tilt identification system subprogram”, and “Facial unusual expression identification system subprogram”. If the person is still an illegal driver, then make a alarming.

Step 2. (a) With the visible light and/or infrared images taken by the visible light, low-light and/or infrared camera devices and the thermo-luminous infrared images taken by the thermo-luminous infrared camera devices, through a face identification processing to the face images data in those two kinds of image data made by the face characteristics identification system program individually, confirm that those images are not the ones of the same person. In addition, the thermo-luminous infrared camera devices and/or the thermo-luminous electrical infrared sensing monitors sense normal infrared radiation from the face skin, which indicates the situation of (b) or (c). In the case of situation (c), It is possible to measure the temperature of face skin through the infrared intensity, which can measure the infrared penetrability to the facemask. Run the “Facemask identification and monitoring system program” to inspect whether or not the driver wears facemask. If the person wears the facemask, then send an alarm.

(b) In the situation (c), firstly, compare with the face image characteristics of legal driver in the biological identification characteristics databank. If the person in the vehicle is an illegal driver, then run “Facial ornaments identification system subprogram”, “Face tilt identification system subprogram”, and “Facial unusual expression identification system subprogram” to correct those mistakes. If the person is still an illegal driver, then make a alarming.

Step 3. On the one hand, the visible light and/or infrared images taken by the visible light, low-light and/or infrared camera devices indicate that those images are the ones of the same person, and on the other hand, the thermo-luminous infrared camera devices and/or the thermo-luminous electrical infrared sensing monitors are unable to sense normal infrared radiation from the face skin or are able to measure very weak infrared radiation from the face skin, which indicates the situation of (d) or (e); then send an alarm or run “Facial ornaments identification system subprogram”, “Face tilt identification system subprogram”, and “Facial unusual expression identification system subprogram” to correct those mistakes. If the person is still an illegal driver, then make a alarming.

Step 4. (a) With the visible light and/or infrared images taken by the visible light, low-light and/or infrared camera devices and the thermo-luminous infrared images taken by the thermo-luminous infrared camera devices, through a face identification processing to the face images data in those two kinds of image data made by the face characteristics identification system program individually, confirm that those images are the ones of the same person. In addition, the thermo-luminous infrared camera devices and/or the thermo-luminous electrical infrared sensing monitors can sense normal infrared radiation from the face skin, which indicates the situation of (a). When comparing with the face image characteristics of legal driver in the biological identification characteristics databank, if it is impossible to confirm whether or not the person in the vehicle is an legal driver (or the system program of comparing with the face image characteristics of legal driver in the biological identification characteristics databank is not carried out), then run “Facial ornaments identification system subprogram”, “Face tilt identification system subprogram”, and “Facial unusual expression identification system subprogram”. If the person is found out that he/she wears facial ornaments or his/her face isn't directed at the camera, then provide a prompt to the driver, asking him/her to remove out his/her ornaments, or correct his/her facial unusual expression or his/her face being directed at the camera, retake his/her face image for re-carrying out face identification and remaking a comparison. If the driver is found out as a legal one, then ask the diver to wear his/her ornaments on, retake his/her face image data and store them (or the face characteristics data of the driver with the facemask, facial ornaments or tiled face taken before) in the biological characteristics databank of legal drivers as that driver's new face characteristics data. If the driver is found out as an illegal driver, make an alarm processing.

It is possible to carry out above-mentioned overall processing procedure, or to carry out a partial processing procedure, or to change the flow sequence according to the design requirements. For example, the process (b) comparing with the face image characteristics of legal driver in the biological identification characteristics databank in not carried out, and directly run other program to judge whether or not the person wears facemask or ornaments such as sunglasses etc, ask him/her to remove out his/her facemask or ornaments, so as to take his/her real images.

After carrying out “Facemask identification system subprogram”, in the case the criminal suspect wears facemask, then carry out “Facial ornaments identification system subprogram” to inspect which type and which model of the facemask the criminal suspect wears.

That “Facemask and facial ornaments identification system subprogram by camera devices” can be also used in each kind of monitor systems with different functions; for example, it can be used in the monitor system in the ATM machine for the bank use. If the person who wants to draw money from the ATM machine wears a facemask or ornaments, the ATM machine will give a prompt to the person to remove his/her facemask or ornaments. If the person keeps wearing his/her facemask or ornaments, then the ATM machine will refuse to pay him/her. If carrying out overall flow procedure, ATM machine can test the face of the person who wants to draw money from the ATM machine, so as to increase a safeguard.

This processing method also can be used in any places where there are needed that method such as bank, building, office, warehouse, home etc, and/or each kind of vehicles, ships, air planes and so on for safety, monitoring and alarming, and face identification burglar lock and so on. In addition, this processing method can be used as a safety alarm for instrument, equipment or other valuables, used for test each materials and for each biological identification, such as face identification technique, iris identification, retina identification, fingerprint identification, voice recognition, identification of the shape of a mouth, and handwriting identification, etc.

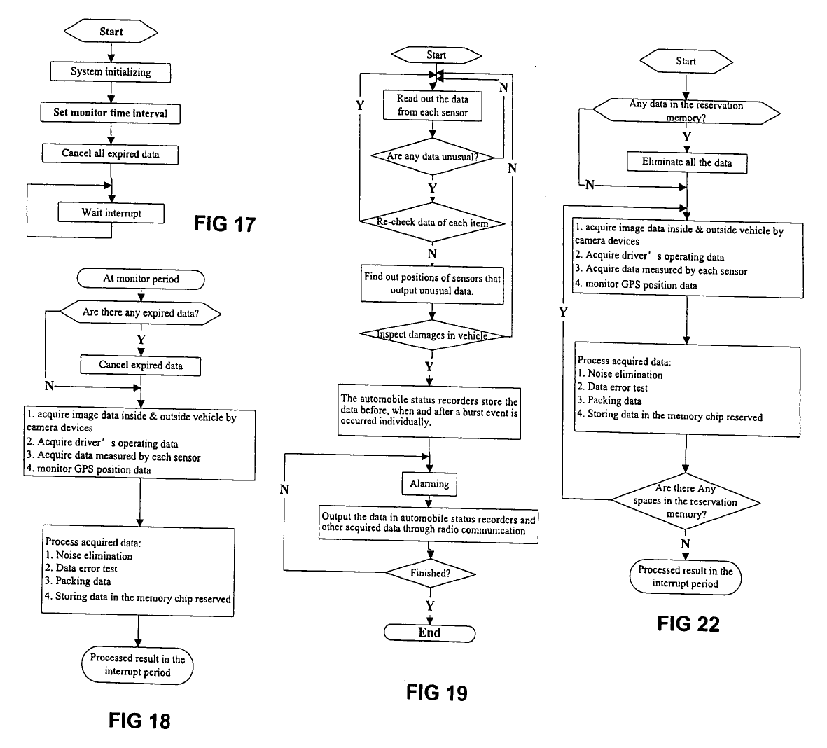

FIG. 17 is the present invention's monitoring program block diagram of automobile status recorder (Auto Black Box).

An automobile status recorder (Black Box for Automobile Use) can record the images and data information inside and outside the automobile captured by the camera devices before a burst event (such as an automobile accident, an attack of the criminal suspect to the driver) is happened and/or when the burst event is being happened and/or after the burst event has happened. Using memory and recorder equipment, such as memory card 3 FLASH ROM) 123c etc, record the data picked up. While a burst event is occurring, a radio communication automobile status recorder that will transmit those data through a radio communication system becomes as an automobile status recorder (Auto Black Box), or called as “Before, when and after occurrence of a burst event automobile status recorder”, including the following contents:

(1) The recording before the burst event is occurred. Using the memory headspace in the mobile memory card 3 (FLASH ROM) 123c in the CPU module of the present invention's automobile safety defense and alarm system, cyclically record the images data captured by the camera devices that are mounted inside or outside the vehicle and the voice data received by the sound sensors that are mounted inside or outside the vehicle in a certain period, such as the images of road and traffic conditions captured by the camera devices and/or the images in the vehicle, GPS information, communication contents of the communication module 130, each kind of automobile status information data collected by alarm sensor and each sensor for vehicle-locking module, such as speed, rotation of the engine, oil quantity, the safety belt is tied or the alarm lamp is on? While a burst event is occurring, stop recording and record the recorded data in the “Before occurrence of a burst event automobile status recorder”.

(2) The recording when and after the burst event is occurred/has been occurred. Using the memory headspace in the mobile memory card 3 (FLASH ROM) 123c in the CPU module of the present invention's automobile safety defense and alarm system, record the images data captured by the camera devices that are mounted inside or outside the vehicle when and after the burst event is occurred/has been occurred and the voice data received by the sound sensors that are mounted inside or outside the vehicle when and after the burst event is occurred/has been occurred, such as the images of road and traffic conditions captured by the camera devices and/or the images in the vehicle, GPS information, communication contents of the communication module 130, each kind of automobile status information data collected by alarm sensor and each sensor for vehicle-locking module and record the recorded data in the “When and after an occurrence of a burst event automobile status recorder”.

(3) According to the calculation requirements or preset condition, such as which kind of the burst event and so on, using the radio system to send the data in “Before, when and after occurrence of a burst event automobile status recorder” to the monitor and control center. After the burst event was occurred, call out those data from the monitor and control center and compare them with the data in the automobile status recorder (Auto Black Box) to analyze the reasons that the burst event was resulted.

The application of “Before occurrence of a burst event automobile status recorder” (Auto Black Box) of the present invention includes the methods of recording, monitoring and processing the data in the camera device (and/or digital camera) and/or sound-receiving module 110, communication module 130, CPU module 120, alarm sensor and vehicle-locking module 140 and GPS positioning module 160 and the data in the vehicle wireless radar RF module and/or ultrasonic radar module as well as the data on vehicle running and road status and so on.

The processing procedure is as follows:

(a) After starting the system, firstly, carry out system initialization to check the operation status of each part and confirm the time length and interval for monitoring record, and cancel expired data and wait interrupting of the monitor.

(b) During the period of monitoring, firstly, inspect whether there are expired data in the time memory and cancel them. (b1) Acquire image data captured by internal and external monitor cameras; (b2) Acquire the operation data of the driver; (b3) Acquire the monitored data received by each sensor, such as Volkswagenwerk Aldi ( [symbol] [symbol] ) computer test system (vts2002) can test all the data of all electronic control system mounted in present Volkswagenwerk Aldi ( [symbol] [symbol] ) series automobiles; (b4) Acquire the monitored data to monitor the data from GPS positioning system and other data.

(c) Process acquired data, for example (1) Noise suppression; (2) Data error test (3) Data packing and other data processing.

(d) Store the data in the memory chip, ending the interrupt processing. It is possible to send the data to the monitor and control center through radio communication system or to file them for treatment. FIG. 19 is the present invention's block diagram of monitoring and alarming system when a burst event to a vehicle is happened. FIG. 22 is the present invention's monitoring program block diagram of a radio communication automobile status recorder (auto black box) when and after a burst event is happened. They jointly form a radio communication automobile status recorder on the burst events, which may record each kind of the data inside and outside the vehicle and other data before a burst event is happened and when the burst event is being happened and after the burst event has happened.

(e) Store the data in the memory chip, ending the interrupt processing. It is possible to send the data to the monitor and control center through radio communication system or to file them for treatment.

FIG. 18 is the present invention's block diagram of chassis anti-destroying and monitoring system by means of camera devices.

The monitoring and processing method of the present invention on using camera devices to prevent the chassis part from destroying includes the following processing procedures:

Camera device 6a and/or 6b can be set under the chassis. In general, the lens covers cover them, only after the burglar and anti-robbing alarm system is started or after the alarm sensor 7a under the chassis is triggered, the covers are then opened to start devices 6a and 6b for taking pictures. Vehicle radio radar RF module and/or ultrasonic module for ultrasonic radar 7a and/7b 7b are set up at the front and rear of the vehicle with orientation of forward or backward individually or set up at each part outside the vehicle with same or different orientation. At the same time, run the anti-destroying and monitoring system program for alarming.

FIG. 19 is the present invention's block diagram of monitoring and alarming system when a burst event to a vehicle is happened.

The principle and processing method of the present invention on monitoring and alarming system when a burst event to a vehicle is occurred includes the following processing procedures:

(1) Starting; (2) Read out the information data from each alarm sensor; (3) Compare and find out any unusual data; (4) Recheck each item of information data. Some data may be changed greatly if a burst event is occurred. (5) Find out the position of the sensor that outputs unusual data; (6) Inspect the damages in the vehicle; (7) Interrupt storing the data in the “Before occurrence of a burst event automobile status recorder” (Auto Black Box), and keep data record integrity; (8) Start storing and recording the data in the “When and after occurrence of a burst event automobile status recorder” (Auto Black Box), and keep data record integrity; (9) According to a preset requirement, output the data stored in the automobile status recorder (Auto Black Box) acquired before, when and after a burst event is/has been occurred through radio communication method; (10) Finished? (11) End.

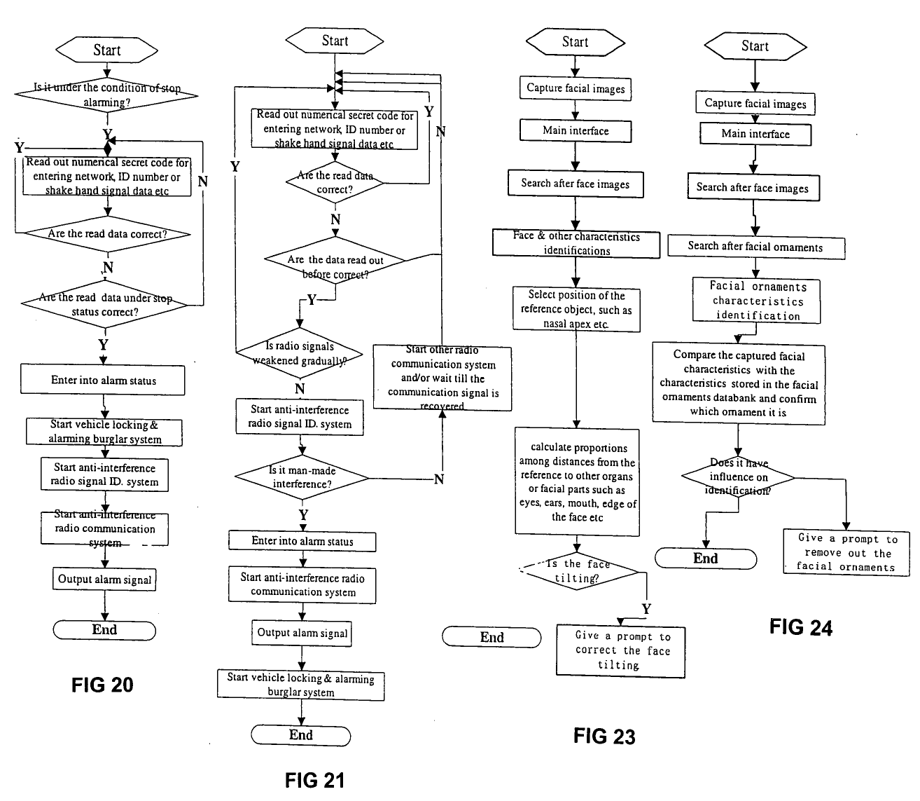

FIG. 20 is the present invention's block diagram of anti-interference radio communication alarming system for vehicle stopping.

The anti-interference radio communication alarming system includes a radio communication system, an anti-interference radio communication monitoring system and an anti-interference radio communication alarming system for vehicle stopping and running. Its principle and processing method is:

When a vehicle is in the stopping and alarming status, in the case the criminal suspect uses a radio communication interference device to interfere the radio communication, at that time, start the anti-interference radio communication alarming system program, which includes the following processing procedures:

(1) Starting; (2) Inspect whether the vehicle is in the stopping and alarming status; (3) Read out and identify the numerical secret codes for entering the Network, such as ID number, shake hand signal data and so on; (4) Test the read-out data; (5) Re-test the read-out communication data if some unusual data are found out; (6) Re-read and identify the numerical secret codes for entering the Network; (7) If that item of data is unusual, enter into alarming status; (8) Start the vehicle locking alarm status and start radio communication interference signal identification system to adjust whether it is a man-made interference. If it is a man-made interference, find out its frequency, signal wave, direction and strength; (9) Start the anti-interference radio communication system to make anti-interference radio communication, for example, changing communication frequency, starting other radio communication system such as USA Pacific Crest Corporation's high-rate data transmission radio station EDL, satellite communication system or other communication method mentioned above; (10) Carry out alarm communication; (11) End.

According to the design requirements, select overall or several processing steps and equip with the equipment corresponding to them.

FIG. 21 is the present invention's block diagram of anti-interference radio communication alarming system for vehicle running.

When a vehicle is in the running and alarming status, in the case the criminal suspect uses a radio communication interference device to interfere the radio communication, at that time, start the anti-interference radio communication alarming system program, which includes the following processing procedures:

(1) Starting; (2) Read out and identify the numerical secret codes for entering the Network, such as ID number, shake hand signal and so on; (3) Test the read-out data; (4) Re-test the read-out communication data if some unusual data are found out; If they are unusual data, then test the data read out before; (5) Is the radio signal is weakening gradually or is the background noise increased greatly? (6) If it is found out that the radio signal is not weakened gradually or the background noise is increased greatly, then we can consider it is a man-made interference, start the radio communication interference identification system; (7) After confirming it is a man-made interference, then enter into alarming status, and start the anti-interference radio communication system, and find out its frequency, signal wave, direction and strength; (8) Start the anti-interference radio communication system to make an anti-interference radio communication, for example, changing communication frequency, starting other radio communication system such as USA Pacific Crest Corporation's high-rate data transmission radio station EDL, satellite communication system or other communication method mentioned above; or wait till the communication signal is normal; (9) Transmit alarming information; (10) Start the vehicle locking burglar alarm system.

According to the design requirements, select overall or several processing steps and equip with the equipment corresponding to them.

FIG. 22 is the present invention's monitoring program block diagram of a radio communication automobile status recorder (auto black box) when and after a burst event is has been occurred.

Using the memory headspace in the mobile memory card 3 (FLASH ROM) in the CPU module of the present invention's automobile safety defense and alarm system or a separate memory card, record the images data captured by the camera devices that are mounted inside or outside the vehicle and the voice data received by the sound sensors that are mounted inside or outside the vehicle in a certain period, such as the images of road and traffic conditions captured by the camera devices and/or the images in the vehicle, GPS information, communication contents of the communication module 130, each kind of automobile status information data collected by alarm sensor and each sensor for vehicle-locking module, such as speed, rotation of the engine, oil quantity, the safety belt is tied or the alarm lamp is on? While a burst event is occurring, using the radio system to send the data in the “Burst event automobile status recorder” (Auto Black Box) to the monitor and control center. After a burst event was occurred, call out those data from the monitor and control center and compare them with the data in the automobile status recorder (Auto Black Box) to analyze the reasons that the burst event was resulted.

The application of “Burst event automobile status recorder” (Auto Black Box) of the present invention includes the methods of recording, monitoring and processing the data in the camera device (and/or digital camera) and/or sound-receiving module 110, communication module 130, CPU module 120, alarm sensor and vehicle-locking module 140 and GPS positioning module 160 and the data in the vehicle wireless radar RF module and/or ultrasonic radar module as well as the data on vehicle running and road status and so on.

The processing procedure is as follows:

(a) After starting the system, firstly, carry out system initialization to check the operation status of each part.

(b) During the period of monitoring, firstly, inspect whether there are any data in the memory headspace and cancel them.

(c) Acquiring data. (1) Acquire image data captured by internal and external monitor cameras; (2) Acquire the operation data of the driver; (3) Acquire the monitored data received by each sensor, such as Volkswagenwerk Aldi( [symbol] [symbol] ) computer test system (vts2002) can test all the data of all electronic control system mounted in present Volkswagenwerk Aldi( [symbol] [symbol] ) series automobiles; (4) Acquire the monitored data to monitor the data from GPS positioning system and other data.

(d) Process acquired data, for example (1) Noise suppression; (2) Data error test (3) Data packing and other data processing.

(e) Store the data in the memory chip,

(f) When receiving the command of stopping record, or when the power supply is interrupted, or when the memory is full, then ending the interrupt processing.

According to the design requirements, it is possible to send the data collected before, when and after a burst event is/has been occurred to the monitor and control center through radio communication system when and after the burst event is/has been occurred, and to file them for treatment by the monitor and control center.

FIG. 23 is the present invention's block diagram of <Face Identification System> to identify whether or not the driver's face is directed at the camera.

During the time of running the “Face Identification System Program”, if the driver's face is not directed at the camera, the images captured by the camera will be tilting, which could cause difficulty for face identification. In order to solve that problem, a “Face tilt identification system program” is needed.

The principle and method of “Face tilt identification system program” of the present invention includes the following processing procedures:

(a) Starting; (b) The camera devices capture the images of the face; (c) Search after face images; (d) Make the face identification; (e) Select position of the reference object, such as nasal apex, or other facial organs. (f) Calculating the distance from other reference objects such as eye, mouth, ear, edge of the face etc, and the proportion with above, lower, right and left edges; (g) Adjust whether or not the face is tilting; (h) If the face is tilting, provide a prompt for correcting; (j) If the face is not tilting, then end the program.

FIG. 24 is the present invention's block diagram of <Face Identification System> to identify whether or not the driver and other peoples have facemask or facial ornaments.

During the time of running the “Face Identification System Program”, if the driver wears facial ornaments, which could cause difficulty for face identification. In order to solve that problem, a “Face ornaments identification system program” is needed. The principle and method of “Face ornaments identification system program” of the present invention includes the following processing procedures:

(a) Starting; (b) The camera devices capture the images of the face; (c) Search after face images; (d) Search for face ornaments or directly carry out the “Face ornaments identification system program”; (e) Carry out the “Face ornaments identification system program”; (f) Compare between the captured images and each biological image of the face with facial ornaments stored in the biological characteristics databank of legal drivers, and confirm which kind of face ornaments it is; (g) Adjust whether or not the face ornament has influence on face identification; (h) If it has influence on face identification, provide a prompt to remove out it from the face; (i) If it has no influence on face identification, then end the program.

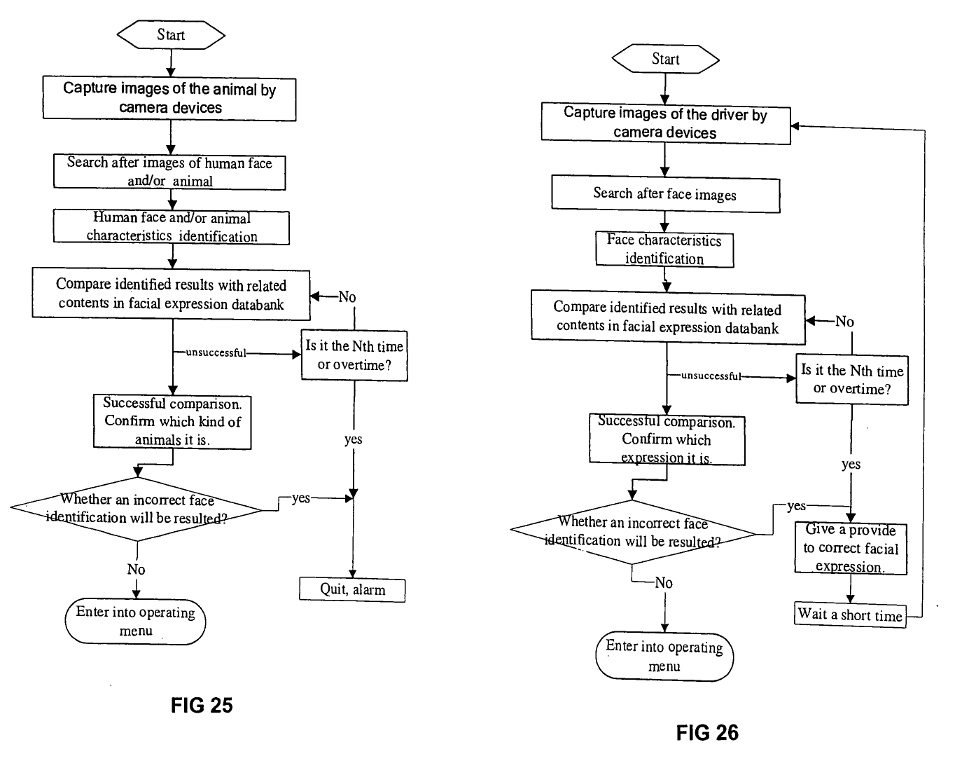

FIG. 25 is the present invention's block diagram of human face and/or animal characters identification and judgment system.

The principle and method of animal characters identification and judgment of the present invention includes the following processing procedures:

(a) Starting; (b) The camera devices capture the images of the animal; (c) Search after animal images; (d) Identify animal characters; (e) Compare between the identification results and the characters of each kind of animal stored in the biological characteristics databank; (f) Identify which kind of animal it is; (g) Adjust whether or not the person and/or that animal has a harmfulness; (h) If it has no harmfulness, then (i) Enter into the operation menu; (j) If it has a harmfulness, then (k) Quit and make an alarm.

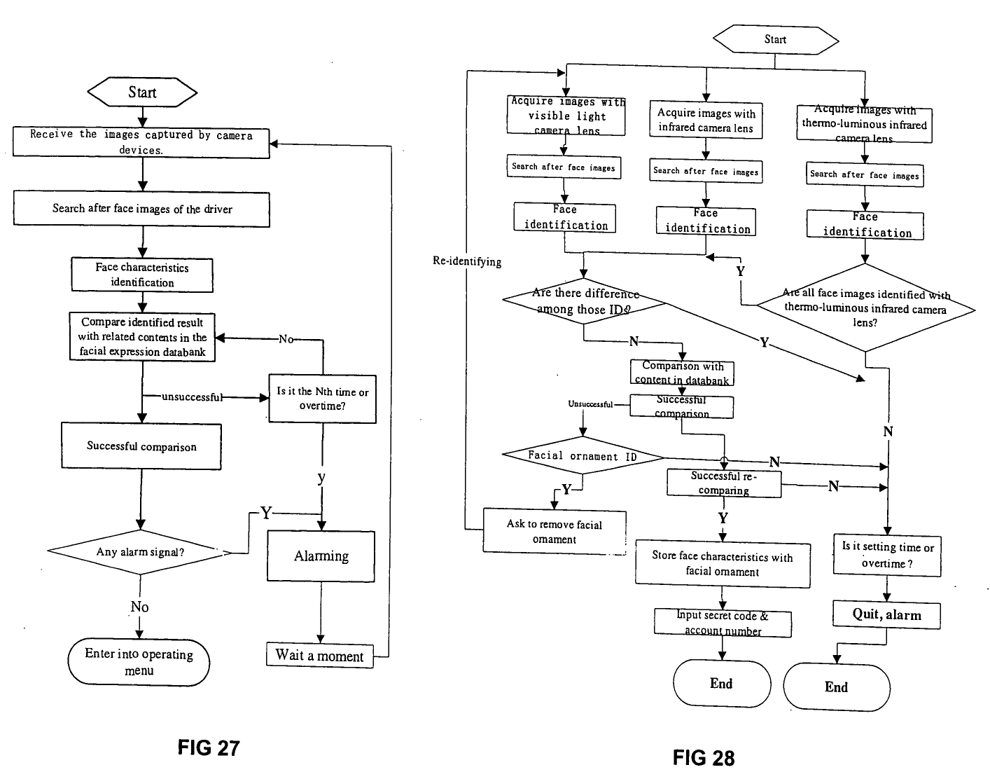

FIG. 26 is the present invention's block diagram of facial unusual expression identification system.

(a) Starting; (b) The camera devices capture the images of the animal; (c) Search after human face and/or animal images; (d) Identify human face and/or animal characters; (e) Compare between the identification results and the characters of each kind of animal stored in the biological characteristics databank; (f) Identify which person or which kind of animal it is; (g) Adjust whether or not the person and/or that animal has a harmfulness; (h) If it has no harmfulness, then (i) Enter into the operation menu; (j) If it has a harmfulness, then (k) Give a prompt to correct the person's face expression and make an alarm.

The principle and method of facial unusual expression identification system of the present invention includes the following processing procedures:

(a) Starting; (b) The camera devices capture the images of the face; (c) Search after face images; (d) Make the face identification; (e) Compare between the identification results and the characters of each kind of facial unusual expression stored in the biological characteristics databank; (f) Identify which kind of facial expression it is; (g) Adjust whether or not that kind of facial expression has an influence on face identification; (h) If it has no negative influence on the face identification, then (i) Enter into the operation menu; (j) If it has influence on face identification, then (k) Provide a prompt to ask the person to correct his/her facial expression.

The sensors in the present invention include sensing device, sensor, inductor, effecter, and so on. They can be used in any places where there are needed that safety defense and alarm system or they can give full play to their functions, such as bank, building, office, warehouse, home etc as well as each kind of vehicles, ships, air planes and so on for safety, monitoring and alarming. In addition, they can be used as a safety alarm for instrument, equipment or other valuables. Using the face identification to confirm whether or not the person in a vehicle or a room is a criminal suspect, or a robber or an animal or an intruder without destructiveness and so on. If it is a criminal suspect, or a robber, an alarm will be sent out. If it is an animal, then using the face identification system program to find out the face image of that animal and its face characteristics like finding out the face image and face characteristics. Compare the animal's characteristics with the characters of each kind of animal stored in the biological characteristics databank. After that comparison, if it is found out that it is an intruder without destructiveness or a legal person, then no alarm will be sent out. If it is a criminal suspect, or a robber or a sabotage, an alarm information will be sent out to a near or remote monitoring center through wireless or wire (such as VF cable, twisted-pair feeder, network connection cable etc) communication system for alarming. This manual of the present invention is a structure explanation of an automobile safety defense and alarm system. If the automobile safety defense and alarm system of the present invention is used in other places than a vehicle, their principles are the same. According to the design requirements, it is possible to change the hardware and/or software, increase and/or reduce the functional modules, and change the installation position of each device. All the changes can not be regarded as being out of the conception of the present invention or being out of the scope limited in our claim attached.

Each kind of modules and each device and element of the present invention as well as each kind of functions can be increased or decreased according to the design requirements. The circuit diagram and program flow diagram in each attached drawing can be modified according to the design requirements and different elements used.

The foregoing detailed description is given for clearness of understanding only and no unnecessary limitation should be understood thereof, as modifications to the automobile safety defense and alarm system with face identification and radio communication functions of the present invention will be obvious to those skilled in the art.

1-32. (canceled)

33. An automobile alarm system comprising an alarming and monitoring sensor, a communication module, a pickup, a CPU module, and one or more camera devices, and/or one or more numerical code camera devices, characterized in that the CPU module receives images captured with the camera device, and/or the numerical code camera devices and that the CPU module runs a face identification system which includes a facial characteristics and/or biological characteristics identification program and a biological characteristics identification database.

34. The automobile alarm system defined in claim 33, wherein said camera devices and/or numerical code camera devices are selected from the group consisting of visible light, low-light camera devices and/or numerical code camera devices, infrared camera devices and/or numerical code camera devices, thermo-luminous infrared camera devices and/or numerical code camera devices, and thermo-luminous electrical infrared camera devices and/or numerical code camera devices, and said facial characteristics identification program includes a facemask identification subprogram, a facial ornaments identification subprogram, a face tilt identification subprogram, and a facial unusual expression identification subprogram.

35. The automobile alarm system defined in claim 33, wherein said automobile alarm system includes a device to promptly ask the person to be identified to take corresponding action and to retake his/her images for face identification when the CPU module runs the facial characteristics identification program.

36. The automobile alarm system defined in claim 33, wherein said automobile alarm system includes a head up display and camera devices with forward and backward and sideward directions inside and outside a vehicle, said head up display selectively displays the images captured with visible light, low-light camera devices and/or numerical code camera devices, infrared camera devices and/or numerical code camera devices, thermo-luminous infrared camera devices and/or numerical code camera devices, forming a night viewing, side/back viewing head up display system.

37. The automobile alarm system defined in claim 33, wherein said automobile alarm system further comprises a redundant device and/or a redundant functional module, an automobile redundant monitoring system, and/or an anti-destroying detecting system.

38. The automobile alarm system defined in claim 33, wherein said automobile alarm system includes monitoring sensors, camera devices and/or numerical code camera devices set up under the chassis, and a automobile burglar alarm program run by the CPU module.

39. The automobile alarm system defined in claim 33, wherein said automobile alarm system comprises an automobile status recorder (auto black box) for burst events recording the images and data information captured by the camera devices or the monitoring sensors before, when and after the burst event occurs, which will be read out for analysis after the burst event occurs or transmitted to a control center by the radio communication system for filing or making other processing.

40. The automobile alarm system defined in claim 33, wherein said automobile alarm system includes an iris identification system, and/or a retina identification system, and/or a voice recognition, and/or a handwriting identification.

41. A burglar alarming method for an automobile vehicle comprising:
verifying the location where a person attempts to enter the vehicle by taking an image of the person;
sending the image to a CPU module;
verifying whether or not the person is a legal driver of the vehicle by using a facial identification program and a specially designated facial characteristics database;
if the person is found as an illegal driver, starting an alarm and communication program to collect the data on face image of the person who has entered the vehicle and/or the images and information in the vehicle captured by a camera device, after packing or non-packing the image data according to each packing protocol for the image transmission, and then transmitting those images and voice data or packed image and voice data and other automobile status information and preset each kind of information to a preset remote monitor and control center for alarming;
starting a burglar and anti-robbing control system program and implementing the commands sent from the vehicle and/or preset burglar and anti-robbing measures to carry out vehicle burglar and anti-robbing control.

42. A facial identification method for detecting whether or not a person wears a mask comprising:
providing a visible light, low-light camera or digital camera device, an infrared camera or digital camera device, and a thermo-luminous infrared camera or digital camera device;
taking an image of the person to be identified with the visible light, low-light camera or digital camera device, the infrared camera or digital camera device, and the thermo-luminous infrared camera or digital camera device, respectively;
comparing the images of the person taken with the visible light, low-light camera or digital camera device, the infrared camera or digital camera device, and the thermo-luminous infrared camera or digital camera device, so as to determine whether the person wears a mask that transmits infrared light, but not visible light, or that transmits neither infrared light nor visible light.

43. The automobile alarm system defined in claim 33, wherein said automobile alarm system comprises an anti-interference radio communication alarming system, an anti-interference radio communication system, and an anti-interference radio communication monitoring system.

44. The automobile alarm system defined in claim 34, wherein the CPU module performs the following processing procedures:
(a) starting; (b) the camera device capturing the images of the face; (c) searching after face images; (d) making the face identification; (e) selecting position of the reference object, such as nasal apex, or other facial organs. (f) calculating the distance from other reference objects such as eye, mouth, ear, edge of the face etc, and the proportion with above, lower, right and left edges; (g) adjusting whether or not the face is tilting; (h) if the face is tilting, providing a prompt for correcting; (j) if the face is not tilting, then end the program.

45. The automobile alarm system defined in claim 33, wherein said automobile alarm system can be connected to a network for its application through radio communication, cable communication, or a remote network monitor system having a facial identification function.

46. The combination defined in claim 33, wherein said automobile alarm system includes a network monitor program having a facial characteristics identification program, and/or a monitor program for making facial identification of the person who wears facemask or facial ornaments.
